(19) United States
(12) Patent Application Publication
(10) Pub. No.: US 2023/0394826 A1
(43) Pub. Date: Dec. 7, 2023

(54) DATA PROCESSING DEVICE AND METHOD, AND DATA PROCESSING SYSTEM

(71) Applicant: SONY GROUP CORPORATION, TOKYO (JP)

(72) Inventors: YASUAKI YAMAGISHI, TOKYO (JP); HIROSHI KUNO, TOKYO (JP); KAZUHIKO TAKABAYASHI, TOKYO (JP)

(21) Appl. No.: 18/246,353

(22) PCT Filed: Oct. 5, 2021
(86) PCT No.: PCT/JP2021/036732

§ 371 Date: Mar. 23, 2023

(30) Foreign Application Priority Data
Oct. 19, 2020 (JP) 2020-175091

(51) Int. Cl. G06V 20/40; G06V 10/60; G06V 10/74

(52) U.S. Cl. CPC G06V 20/44; G06V 10/761; G06V 10/60

(57) ABSTRACT

The present disclosure relates to a data processing device and method, and a data processing system, capable of reducing application loads in a cloud server by controlling sensor data flowing over a network.

A sensor data monitor controls, based on a result of determining a sameness of subjects using DVS data output from DVS sensors that output temporal luminance changes in optical signals as event data, data transfer of image frame data in which the subjects have been shot on a frame basis. The present disclosure can be applied in, for example, an image network system or the like that transmits image frame data shot on a frame basis.

### TECHNICAL FIELD

The present disclosure relates to a data processing device and method, and a data processing system, and particularly relates to a data processing device and method, and a data processing system, capable of reducing application loads in a cloud server by controlling sensor data flowing over a network.

### BACKGROUND ART

The use of IoT devices is increasing. For example, there is a network video system in which a camera is provided with network connection functionality, and recognition processing and the like for images shot by the camera are performed on a cloud server (see, for example, NPL 1 and NPL 2).

### CITATION LIST

### Non Patent Literature

[NPL 1]
IDK Inc., “An IDK Original Series: Understanding Network Cameras—A Basic Course (No. 5), Network Camera Network & System Technology”. Retrieved Sep. 28, 2020, from https://www.idknet.co.jp/network_camera/column5/.
[NPL 2]
Fujii, Tetsuro, “Next-Generation Security Camera Technology Research Special Committee—State of Video IoT Utilizing Image Processing”, Feb. 17, 2017. Retrieved Sep. 28, 2020, from http://jniaa.com/files/uploads/ [symbol] [symbol] _170217.pdf.

### SUMMARY

### Technical Problem

As the number of network cameras increases in the future, traffic of redundant video data obtained by shooting the same subject will increase as well, causing increased loads and conflicts in applications in cloud servers, which may result in a situation in which the necessary data cannot be processed correctly.

Having been conceived in light of such a situation, the present disclosure makes it possible to reduce application loads in a cloud server by controlling sensor data flowing over a network.

### Solution to Problem

A data processing device according to a first aspect of the present disclosure includes a control unit that, based on a result of determining a sameness of subjects using DVS data output from sensors that output temporal luminance changes in optical signals as event data, controls data transfer of image frame data in which the subjects have been shot on a frame basis.

A data processing method according to the first aspect of the present disclosure includes a data processing device controlling, based on a result of determining a sameness of subjects using DVS data output from sensors that output temporal luminance changes in optical signals as event data, data transfer of image frame data in which the subjects have been shot on a frame basis.

In the first aspect of the present disclosure, based on a result of determining a sameness of subjects using DVS data output from sensors that output temporal luminance changes in optical signals as event data, data transfer of image frame data in which the subjects have been shot on a frame basis is controlled.

A data processing system according to a second aspect of the present disclosure includes: a first data control unit that, based on a result of determining a sameness of subjects using DVS data output from sensors that output temporal luminance changes in optical signals as event data, controls data transfer, to a cloud server, of image frame data in which the subjects have been shot on a frame basis; and a second data control unit that transmits the image frame data to the cloud server based on the control performed by the first data control unit.

In the second aspect of the present disclosure, based on a result of determining a sameness of subjects using DVS data output from sensors that output temporal luminance changes in optical signals as event data, data transfer of image frame data in which the subjects have been shot on a frame basis to a cloud server is controlled; and based on that control, the image frame data is transmitted to the cloud server.

Note that the data processing device according to the first aspect of the present disclosure and the data processing system according to the second aspect can be realized by causing a computer to execute a program. The program to be executed by the computer can be provided by transmitting through a transmission medium or by recording on a recording medium.

The data processing device and the data processing system may be separate apparatuses, or internal blocks constituting a single apparatus.

### BRIEF DESCRIPTION OF DRAWINGS

FIG. 1 is a diagram illustrating an example of the application of an image network system of the present disclosure.

FIG. 2 is a diagram illustrating an example of the application of the image network system of the present disclosure.

FIG. 3 is a diagram illustrating event data output by a DVS sensor.

FIG. 4 is a diagram illustrating an example of the event data output by the DVS sensor.

FIG. 5 is a diagram illustrating a relationship between event data and image frame data.

FIG. 6 is a diagram illustrating a relationship between event data and image frame data.

FIG. 7 is a block diagram illustrating an example of the configuration of an image network system, which is an embodiment of a data processing system according to the present disclosure.

FIG. 8 is a flowchart illustrating first transmission control processing by the image network system.

FIG. 9 is a flowchart illustrating, in detail, EAS attribute registration processing in FIG. 8.

FIG. 10 is a flowchart illustrating, in detail, sameness determination processing in FIG. 8.

FIG. 11 is a diagram illustrating a specific example of subject sameness determination processing using DVS data.

FIG. 12 is a flowchart illustrating second transmission control processing by the image network system.

FIG. 13 is a diagram illustrating the determination of a capture timing.

FIG. 14 is a diagram illustrating differential transfer processing and original restoration processing.

FIG. 15 is a flowchart illustrating third transmission control processing by the image network system.

FIG. 16 is a diagram illustrating the assignment of ROI viewports.

FIG. 17 is a block diagram illustrating user equipment in detail.

FIG. 18 is a block diagram illustrating EAS in detail.

FIG. 19 is a block diagram illustrating a sensor data monitor in detail.

FIG. 20 is a block diagram illustrating EES in detail.

FIG. 21 is a diagram illustrating the formats of event packets and image packets.

FIG. 22 is a diagram illustrating an example of image packet data, indicating a correspondence relationship between base image frame data and difference image frame data.

FIG. 23 is a diagram illustrating another example of control of the image network system of the present disclosure.

FIG. 24 is a block diagram illustrating an example of the configuration of an embodiment of the computer to which the technique of the present disclosure is applied.

### DESCRIPTION OF EMBODIMENTS

A mode for embodying the present disclosure (hereinafter referred to as an embodiment) will be described below with reference to the accompanying drawings. In the present specification and the drawings, constituent elements having substantially the same functional configuration will be denoted by the same reference numerals, and thus repeated descriptions thereof will be omitted. The description will be made in the following order.
1. Overview of Image Network System of Present Disclosure
2. Example of Configuration of Image Network System
3. First Transmission Control Processing of Image Frame Data
4. Second Transmission Control Processing of Image Frame Data
5. Third Transmission Control Processing of Image Frame Data
6. Block Diagram
7. Example of Transmission Formats of Event Data and Image Frame Data
8. Other Control Examples
9. Example of Configuration of Computer

<1. Overview of Image Network System of Present Disclosure>

First, an overview of the image network system of the present disclosure will be described.

Recent years have seen growing momentum in the utilization of IoT devices, as well as sensing data obtained from IoT devices using artificial intelligence (AI) and the like. However, injecting the large amount of data generated by IoT devices into a network indiscriminately may result in the data that is truly needed not being processed correctly. On the other hand, securing excessive network resources to accommodate cases of sudden bursts of data will incur extra costs. As such, it is desirable to reduce the traffic in the network and the processing load on applications that process data by discarding or selecting data according to service requirement conditions before injecting the data into the network.

For example, assume that there is a service requirement condition for a recognition processing service in which when the same subject appears in multiple images shot by a large number of cameras, it is sufficient to execute object recognition processing for one subject on the image shot by a single one camera.

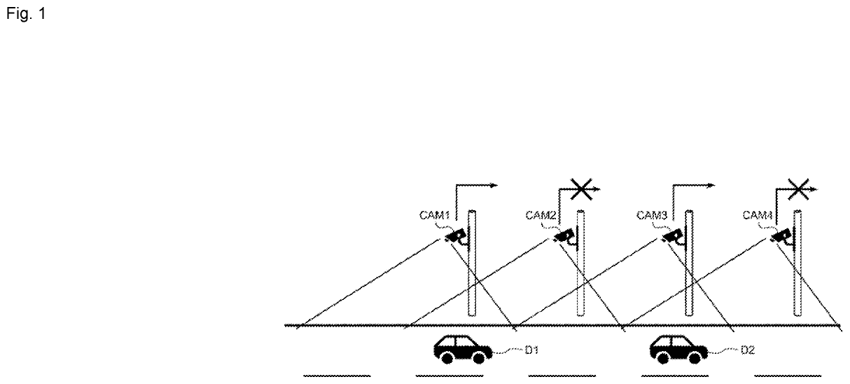

As a specific example, as illustrated in FIG. 1, a plurality of traffic cameras CAM1 to CAM4 are installed on a road, and each of the plurality of traffic cameras CAM1 to CAM4 shoots an image of vehicles D passing on the road and transmits the image to an application in the cloud. The images shot by the traffic cameras CAM1 and CAM2 show a vehicle D1 as the subject, and the images shot by the traffic cameras CAM3 and CAM4 show a vehicle D2. In this case, for the vehicle D1, the image shot by the traffic camera CAM1 is transmitted to the application in the cloud, whereas the image shot by the traffic camera CAM2 is not transmitted to the network, which reduces the traffic in the network and the processing load on the application that processes the data. For the vehicle D2 too, the image shot by the traffic camera CAM3 is transmitted to the application in the cloud, whereas the image shot by the traffic camera CAM4 is not transmitted to the network, which reduces the traffic and the processing load on the application.

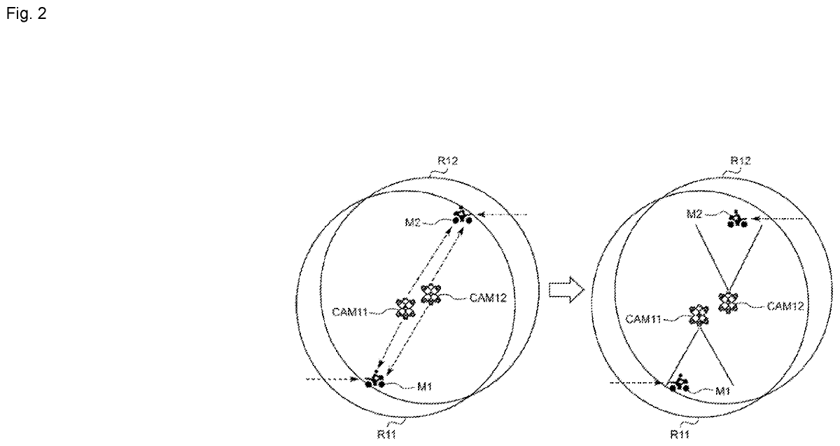

As another example, 360-degree cameras CAM11 and CAM12 are disposed in such a way that the capturing ranges thereof partially overlap, as illustrated on the left side of FIG. 2. The capturing range of the 360-degree camera CAM11 is an area R11, and the capturing range of the 360-degree camera CAM12 is an area R12.

The left side of FIG. 2 illustrates a state in which the two 360-degree cameras CAM11 and CAM12 simultaneously capture two motorcycles M1 and M2 traveling at high speed. In this case, as illustrated on the right side of FIG. 2, the 360-degree camera CAM11 generates, and transmits to an application in the cloud, a packing image in which the area in which the one motorcycle M1 appears is assigned a high resolution and a high ratio relative to the total display area. On the other hand, the other 360-degree camera CAM12 generates, and transmits to an application in the cloud, a packing image in which the area in which the other motorcycle M2 appears is assigned a high resolution and a high ratio relative to the total display area. Thus, when subjects captured by a plurality of cameras overlap, high-resolution images that assign high-resolution areas to subjects that differ from each other are transmitted to the application, which enables more objects to be captured simultaneously in high resolution for recognition processing, analysis processing, and the like.

There are many other conceivable situations in which the same subject can appear in images shot by a plurality of cameras, such as a system in which a plurality of drones are flown to a certain venue and images shot by the drones' cameras are subjected to recognition processing for monitoring, a system in which a plurality of patrol robots provided with cameras patrol a factory for monitoring, and the like.

An image network system of the present disclosure makes processing such as that illustrated in FIGS. 1 and 2 possible when there is a service requirement condition in which, for a single subject, it is sufficient to execute object recognition processing on images shot by at least one camera. This makes it possible to reduce traffic in the network, reduce the processing load on an application that performs recognition processing or the like, perform efficient or highly-accurate recognition processing, and the like.

More specifically, the image network system of the present disclosure determines the sameness of a subject by using a DVS sensor as a camera that shoots the subject, and based on a result of the determination, controls shot data from an image sensor that performs frame-based shooting.

The DVS sensor will be briefly described.

A DVS sensor is a sensors that has pixels that photoelectrically convert optical signals and output pixel signals, and based on the pixel signals, output temporal luminance changes in the optical signals as event signals (event data). Such an event sensor is also called a dynamic vision sensor (DVS), an event-based vision sensor (EVS), or the like. A general image sensor shoots images in synchronization with a vertical synchronization signal and outputs frame data, which is one frame's (screen's) worth of image data in the period of the vertical synchronization signal, but a DVS sensor outputs event data only at the timing when an event occurs, and is therefore an asynchronous-type (or address control-type) camera. The following will refer to image sensors that output frame-based image data in a predetermined period (framerate) as “FIS sensors” to distinguish them from DVS sensors.

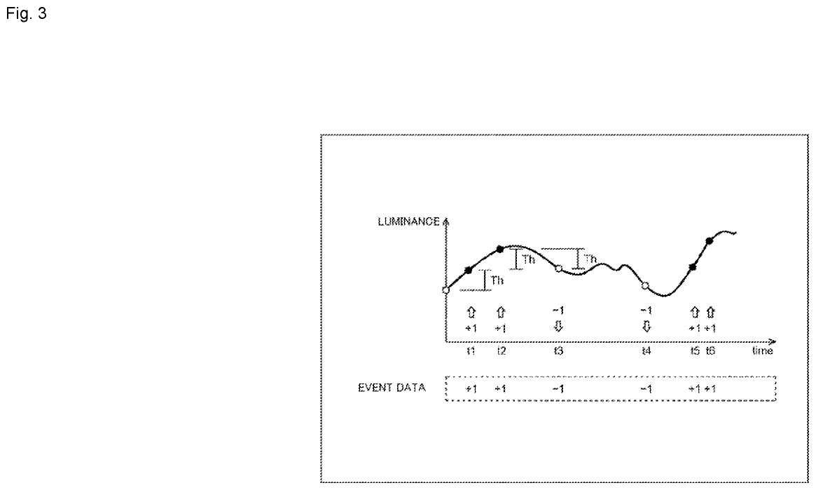

FIG. 3 illustrates time-series event data output by a predetermined single pixel of the DVS sensor.

In the DVS sensor, for example, a voltage signal corresponding to the logarithmic value of the received light amount incident on each pixel is detected as the pixel signal. The DVS sensor outputs “+1”, representing a luminance change in the positive direction, when the luminance change represented by the pixel signal exceeds a predetermined threshold Th and becomes brighter, and “−1”, representing a luminance change in the negative direction, when the luminance change exceeds the predetermined threshold Th and then becomes darker.

In the example illustrated in FIG. 3, the predetermined pixel of the DVS sensor outputs “+1” at time t1, “+1” at time t2, “−1” at time t3, “−1” at time t4, “+1” at time t5, and “+1” at time t6. As illustrated in FIG. 3, the interval between each of times t1, t2, t3, and so on up to t6 is not constant.

The event data is expressed, for example, in the following format, which is called Address-Event Representation (AER).

ev=(x,y,p,t) (1)

In Formula (1), x, y represent the coordinates of the pixel where a luminance change has occurred; p represents the polarity of the luminance change (the positive direction or the negative direction), and t represents a timestamp corresponding to the time when the luminance change occurred.

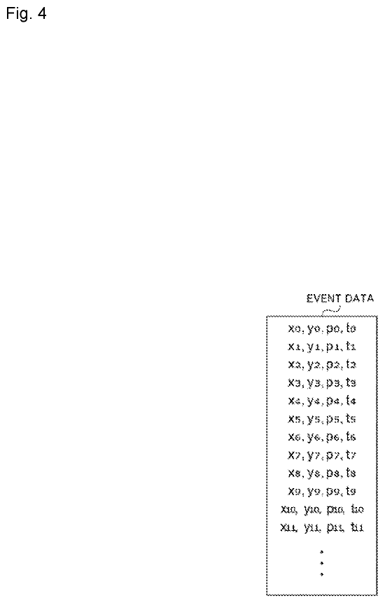

FIG. 4 illustrates an example of the event data of a predetermined single pixel, output by the DVS sensor.

The DVS sensor outputs event data including, for example, coordinates (xᵢ, yᵢ) representing the position of the pixel where the event occurred, a polarity pᵢ of the luminance change serving as the event, and a time t1 when the event occurred, as illustrated in FIG. 4.

The time t1 of the event is a timestamp representing the time when the event occurred, and is expressed, for example, as a count value of a counter based on a predetermined clock signal in the sensor. The timestamp corresponding to the timing the event occurred can be said to be time information representing the (relative) time at which the event occurred, as long as the interval between events is kept the same as when the event occurred.

The polarity pᵢ represents the direction of a luminance change when a luminance change (light intensity change) exceeding a predetermined threshold occurs as an event, and indicates whether the luminance change is in the positive direction (also called simply “positive” hereinafter) or the negative direction (also called simply “negative” hereinafter). For example, the polarity pᵢ of an event is represented by “+1” when the direction is positive and “−1” when the direction is negative.

As described above, the DVS sensor outputs only the position coordinates, polarity, and time information of a pixel that detected a luminance change. Because only net changes (differences), i.e., the position coordinates, polarity, and time information, are generated and output, and because there is no redundancy in the amount of data, the DVS sensor has a high temporal resolution, on the order of psec. Because the amount of information is small, the DVS sensor consumes less power than a frame-based image sensors, and when processing data, there is no unnecessary processing load and the processing time can be shortened. High-speed, low-latency data output is therefore possible, which makes it possible to obtain the exact time at which the event occurred.

The DVS sensor detects subjects at a high temporal resolution and with low latency, and outputs the detections as event data, and can therefore determine the sameness of a subject more quickly than an event sensor that outputs on a frame basis.

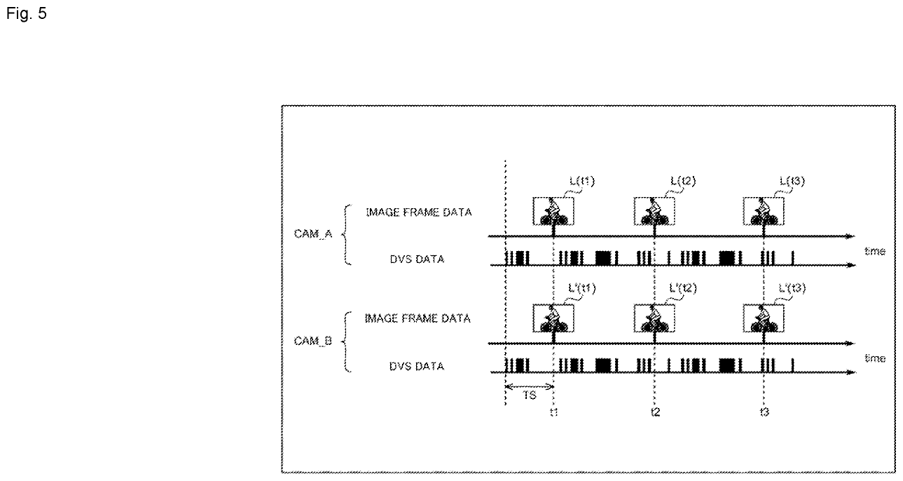

For example, as illustrated in FIG. 5, there are two cameras CAM_A and CAM_B having capturing ranges which at least partially overlap. In this example, each of the two cameras CAM_A and CAM_B has a DVS sensor and an FIS sensor, and the DVS sensor and FIS sensor output data in which a person moving on a bicycle has been captured as a subject.

As described above, the DVS sensor outputs event data at a high temporal resolution and with low latency, and can therefore output data in which the subject is captured faster than the FIS sensor can output frame-based image data. In the example in FIG. 5, the DVS data (event data) can be output by TS time earlier than time t1, which is when the FIS sensor outputs the frame-based image frame data.

Assume that the image frame data output by the FIS sensor of the camera CAM_A at time t1 is an image L(t1), and the image frame data output at time t2 is an image L(t2). Similarly, assume that the image frame data output by the FIS sensor of the camera CAM_B at time t1 is an image L′(t1), and the image frame data output at time t2 is an image L′(t2).

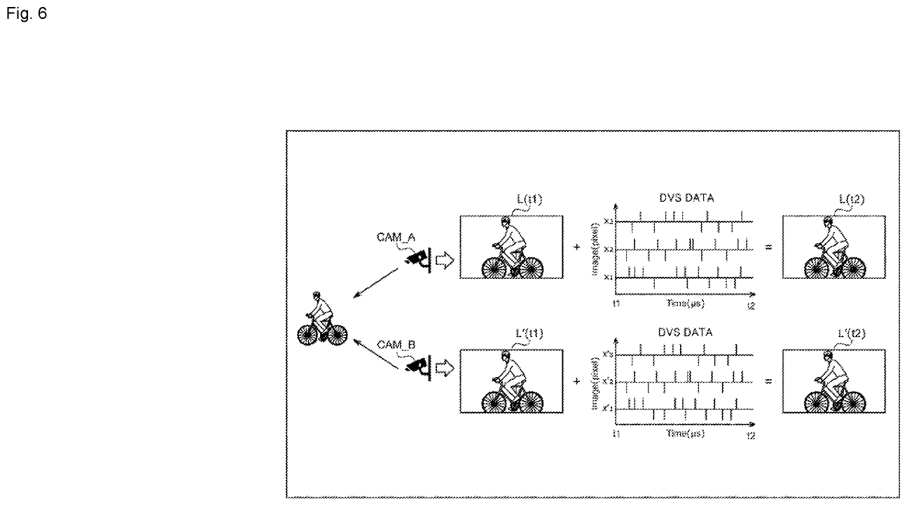

As illustrated in FIG. 6, the image L(t2) output by the FIS sensor of camera CAM_A at time t2 is equal to the image L(t1) at time t1 plus an integral value of luminance according to the event data occurring from time t1 to time t2. Similarly, the image L′(t2) output by the FIS sensor of camera CAM_B at time t2 is equal to the image L′(t1) at time t1 plus the integral value of luminance according to the event data occurring from time t1 to time t2. In FIG. 6, each instance of event data indicated as DVS data indicates event data of pixels having x coordinates of x₁, x₂, and x₃ in the camera CAM_A and x₁′, x₂′, and x₃′ in camera CAM_B, with the lines extending upward from the reference line indicating positive events and the lines extending downward from the reference line indicating negative events.

In the two cameras CAM_A and CAM_B capturing the same subject, events involving movement of the subject occur at the same time, and thus the DVS sensors of the two cameras CAM_A and CAM_B generate event data having almost identical luminance change distributions at the same time. In other words, the time information of the DVS data output by the DVS sensor of the camera CAM_A from time t1 to time t2 and the DVS data output by the DVS sensor of the camera CAM_B from time t1 to time t2 will be identical if the system clocks are perfectly synchronized, while the time information will be different, albeit having the same time intervals between preceding and following data, when the system clocks are not perfectly synchronized.

The relative positional relationships between the x,y coordinates of the DVS data of the cameras CAM_A and CAM_B, which capture the same subject from almost the same angle, will also be almost the same. For example, when event data produced by a pixel having x coordinates of x₁, x₂, x₃ in the DVS sensor of camera CAM_A corresponds to event data produced by a pixel having x coordinates of x₁′, x₂′, x₃′ in the DVS sensor of camera CAM_B, |x₁−x₂|/|x₂−x₃|=|x₁′−x₂′|/x₂′−x₃′| holds true, for example. Although only the x coordinate is indicated and described here, the same applies to the y coordinate, of course.

Therefore, the sameness of the subject can be determined by synchronizing the time information and comparing the DVS data output by the DSV sensor of the camera CAM_A with the DVS data output by the DSV sensor of the camera CAM_B. Because using DVS data makes it possible to determine the sameness of the subject earlier than frame-based image frame data, the output of the image frame data of one of the FIS sensors of the two cameras CAM_A and CAM_B, or the image capture operation itself, can be stopped.

The FIS sensor and the DVS sensor may be provided in a single device and adjusted to have the same image capture range, or may be provided as different devices adjacent to each other and adjusted to have the same image capture range. A single sensor that enables each pixel to output both event data and frame-based image frame data may also be used. For example, the Dynamic and Active-pixel Vision Sensor (DAVIS sensor) disclosed in “Brandli et al., A 240×180 130 dB 3 us latency global shutter spatiotemporal, IEEEJSSC, 2014” can be given as a sensor that enables each pixel to output both event data and frame-based image frame data. The following embodiments will be described using, as an example, a configuration in which an FIS sensor and a DVS sensor are provided separately in a single device.

<2. Example of Configuration of Image Network System>

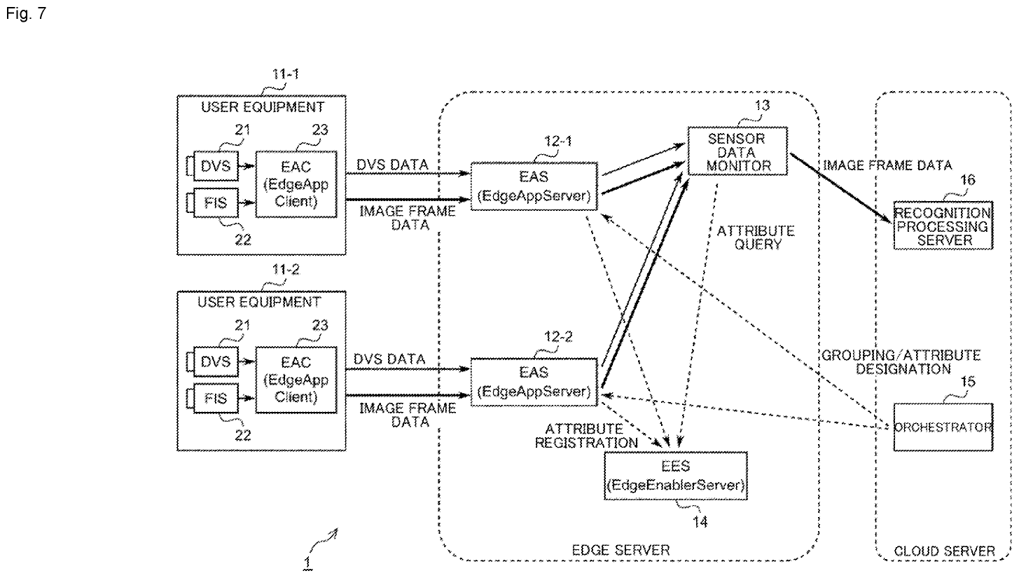

FIG. 7 illustrates an example of the configuration of an image network system, which is an embodiment of a data processing system according to the present disclosure.

An image network system 1 illustrated in FIG. 7 is a system that transmits moving image data shot by a plurality of pieces of user equipment 11 to the cloud over a network and performs image recognition processing in the cloud. Of the plurality of pieces of user equipment 11, only two, namely user equipment 11-1 and 11-2, are illustrated in FIG. 7.

The image network system 1 includes an edge application server (EAS) 12 on the edge side, corresponding to each piece of the user equipment 11. EASs 12-1 and 12-2, which correspond to the two pieces of user equipment 11-1 and 11-2, respectively, are illustrated in FIG. 7.

Furthermore, the image network system 1 includes a sensor data monitor 13, an edge enabler server (EES) 14, an orchestrator 15, and a recognition processing server 16.

The user equipment 11, the EASs 12, the sensor data monitor 13, the EES 14, the orchestrator 15, and the recognition processing server 16 are connected over a predetermined network. For example, the network is configured to include a network or communication path compliant with any communication protocol/standard, for example, the Internet, a public telephone network, a wide area communication network for wireless mobile such as what are known as 4G circuits and 5G circuits, a wide area network (WAN), a local area network (LAN), a wireless communication network for communication compliant with the Bluetooth (registered trademark) standard, a communication path for short-range communication such as near-field communication (NFC), a communication path for infrared communication, a communication network for wired communication compliant with standards such as High-Definition Multimedia Interface (HDMI)(registered trademark) or Universal Serial Bus (USB), or the like.

The user equipment 11 includes a DVS sensor 21, an FIS sensor 22, and an edge application client (EAC) 23.

The DVS sensor 21 is a sensor that detects a temporal luminance change in a pixel as an event and outputs event data expressing the occurrence of an event at the timing at which the event occurred. A general image sensor shoots images in synchronization with a vertical synchronization signal and outputs frame data, which is one frame's (screen's) worth of image data in the period of the vertical synchronization signal, but the DVS sensor 21 outputs event data only at the timing when an event occurs, and is therefore an asynchronous-type (or address control-type) camera.

The FIS sensor 22 is an image sensor that outputs frame-based image data at a predetermined period (a constant framerate). The FIS sensor 22 can be constituted by any type of image sensor that outputs frame-based image data, such as an image sensor that receives RGB light and outputs RGB images, an image sensor that receives IR light and outputs IR images, or the like. The capturing ranges of the DVS sensor 21 and the FIS sensor 22 are set to be identical.

The EAC 23 is client-side application software that forms a pair with an edge application server (EAS) 12 located on the edge side. The EAC 23 transmits DVS data, which is event data generated by the DVS sensor 21, to the corresponding EAS 12. The EAC 23 also transmits the image frame data generated by the FIS sensor 22 to the corresponding EAS 12.

In the following, when distinguishing between the DVS sensor 21, the FIS sensor 22, and the EAC 23 of the user equipment 11-1 and 11-2, respectively, the elements on the user equipment 11-1 side will be referred to as a DVS sensor 21-1, an FIS sensor 22-1, and an EAC 23-1, whereas the elements on the user equipment 11-2 side will be referred to as a DVS sensor 21-2, an FIS sensor 22-2, and an EAC 23-2.

The EAS 12 is application software that executes server functions in an edge environment (an Edge Data Network). The EAS 12 obtains the execution environment of the server functions from the EES 14 and registers groupings and attributes instructed by the orchestrator 15 in the EES 14. The EAS 12 transmits (transfers) DVS data and image frame data received from the client-side EAC 23 serving as the partner in the pair to the sensor data monitor 13 by executing the execution environment obtained from the EES 14. Here, to which device the DVS data and image frame data received from the EAC 23 are to be transmitted is specified in advance by a DVS data generation notification transmitted from the sensor data monitor 13.

As described above, DVS data is received asynchronously (randomly) at the timing at which an event occurs, and image frame data is received at a predetermined framerate, and the timings at which DVS data and image frame data are received are therefore different.

The sensor data monitor 13 queries the EES 14 to recognize the grouping and attributes of each EAS 12. When DVS data is generated, the sensor data monitor 13 transmits a DVS data generation notification, instructing the DVS data to be transmitted to that sensor data monitor 13 itself, to each EAS 12.

The sensor data monitor 13 executes sameness determination processing for determining the sameness of the DVS data transmitted from a plurality of EASs 12 in the same group. The sensor data monitor 13 determines the sameness of the subject by determining the sameness of the DVS data. The sensor data monitor 13 removes redundant image frame data based on the result of determining the sameness of the DVS data transmitted from the plurality of EASs 12 in the same group, and transmits the post-removal image frame data to the recognition processing server 16. For example, the sensor data monitor 13 selects only one piece of the image frame data transmitted from the two EASs and transmits that data to the recognition processing server 16, and suspends the transmission for the other EAS. Alternatively, the sensor data monitor 13 selects only one piece of the image frame data transmitted from the two EASs and transmits that data to the recognition processing server 16, and transmits only difference data from the transmitted image frame data for the other EAS.

The EES 14 provides the execution environment for the server functions in the edge environment to the EASs 12. The EES 14 registers the groupings and attributes of each EAS 12 as notified by that EAS 12, and provides information on the groupings and attributes of each EAS 12 in response to an attribute query from the sensor data monitor 13.

The orchestrator 15 determines the groups to which each EAS 12 belongs and the attributes of each group based on service requirement conditions. Here, “attributes” represent the conditions required for each EAS 12 to handle image frame data, e.g., recognition processing should be performed using one piece of image frame data if there is image frame data in which the same subject in the same group has been captured. The orchestrator 15 instructs each EAS 12 of the groups and attributes determined for the corresponding EAS 12.

The recognition processing server 16 executes predetermined recognition processing based on the image frame data transmitted from the sensor data monitor 13, and outputs a result thereof. The recognition processing server 16 also executes original restoration processing and the like for restoring the difference data to original data when the difference data has been transmitted from the sensor data monitor 13.

The image network system 1 described above is configured in accordance with the architecture for edge applications being standardized by the Third Generation Partnership Project (3GPP)—SA6, which is a standards organization for mobile communications (3GPP TS 23.558, “Architecture for enabling Edge Applications (Release 17)”). The EAC, EAS, and EES are defined in this architecture, and the EASs are provided in pairs with an application client of the user equipment. The EAC is application software that executes client functions of a predetermined application on user equipment, and the EAS is application software that executes server functions of that application in an edge environment (an Edge Data Network). The EAS is specified as registering and updating its own application attributes (EAS Profile ([1].Table.8.2.4-1)) in the EES via EDGE-3. The sensor data monitor 13, the orchestrator 15, and the recognition processing server 16 are entities newly introduced in order to implement the technique of the present disclosure.

The EAS 12, the sensor data monitor 13, and the EES 14 are a set of edge servers provided in an edge environment (an Edge Data Network) and managed by a single EES 14. The EAS 12, the sensor data monitor 13, and the EES 14 may each be constituted by different server devices, or a plurality of functions may be configured in a single server device, or all of the functions may be configured in a single server device. The orchestrator 15 and the recognition processing server 16 are provided as cloud servers in the cloud. The orchestrator 15 and the recognition processing server 16, too, may be constituted by different server devices, or by a single server device.

Using the output data of the DVS sensor 21 (the DVS data), the image network system 1 determines the sameness of subjects shot by the user equipment 11 in the same group and controls redundant image frame data. For example, redundant image frame data is controlled so as not to be transmitted to the recognition processing server 16. This suppresses traffic in the network and makes it possible to lighten the processing load on the recognition processing server 16.

In the present embodiment, the DVS data is used only for determining the sameness and is not transmitted to the recognition processing server 16, but the DVS data may also be transmitted to the recognition processing server 16 according to the details of the processing performed by the recognition processing server 16.

<3. First Transmission Control Processing of Image Frame Data>

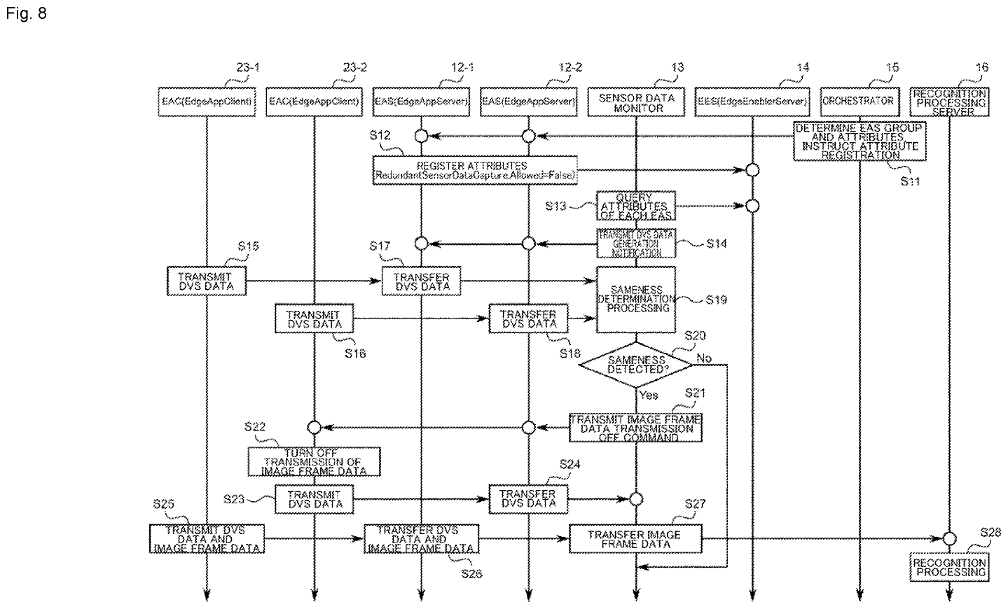

First transmission control processing executed by the image network system 1, which is transmission control processing for stopping the transmission of redundant image frame data based on the result of the subject sameness determination processing performed using the DVS data, will be described next with reference to the flowchart in FIG. 8. The processing in FIG. 8 is started, for example, when an authentication processing service using image frame data is instructed to start.

First, in step S11, the orchestrator 15 determines the group to which each EAS 12 belongs and the attributes thereof based on the service requirement conditions, supplies the determined group and attributes to each EAS 12, and instructs the registration of the attributes.

In step S11 of the first transmission control processing, the orchestrator 15 determines “RedundantSensorDataCapture” as an attribute which is an application attribute of the EAS 12 and which depends on the type of the application in the EAS Service Profile (an extended attribute). The “RedundantSensorDataCapture” attribute has TargetEASGroupID and Allowed as parameters.

The parameter TargetEASGroupID takes an integer value, and expresses a number indicating the group to which EAS 12 belongs. The parameter Allowed takes a logical value of True or False. The parameter Allowed being True indicates that image frame data from all EASs 12 specified by TargetEASGroupID are to be transmitted to the recognition processing server 16. Conversely, the parameter Allowed being False indicates that only image frame data from one EAS 12 among the EASs specified by TargetEASGroupID is to be transferred to the recognition processing server 16, and image frame data from the other EASs 12 is not to be transferred. The parameter Allowed is True by default. The example in FIG. 8 assumes that the EAS 12-1 and the EAS 12-2 are assigned to the same group (e.g., TargetEASGroupID=“1”) and “RedundantSensorDataCapture.Allowed=False” is specified.

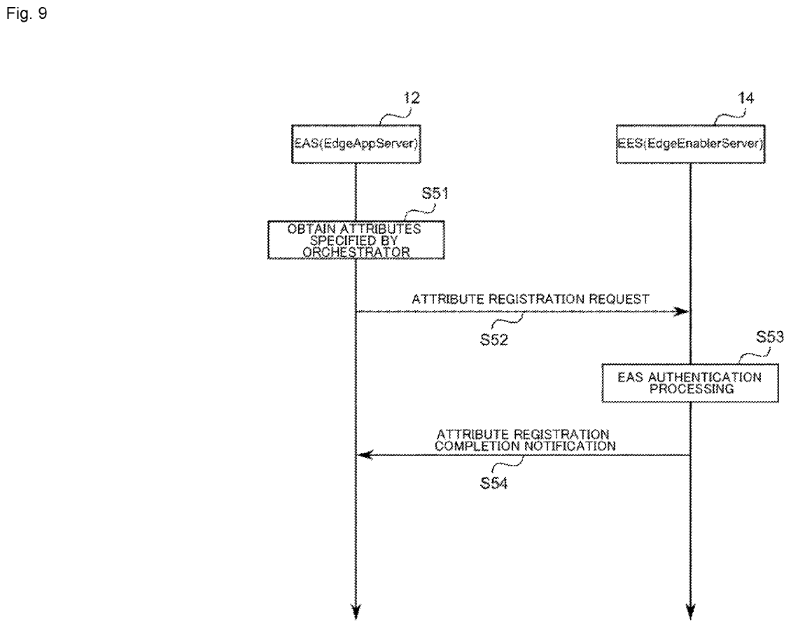

In step S12, the EAS 12-1 and the EAS 12-2 each obtain an attribute registration instruction from the orchestrator 15 and register their own “RedundantSensorDataCapture” attribute in the EES 14. The EES 14 stores the “RedundantSensorDataCapture” attribute of each EAS 12 as communicated by each EAS 12. The EES 14 also accepts attribute registrations from EASs 12 other than the EAS 12-1 and the EAS 12-2. Through this, the EES 14 stores which group each EAS 12 belongs to and how the parameter Allowed is set. The attribute registration processing will be described in detail later with reference to FIG. 9. Below, in the first transmission control processing, “attribute” refers to the “RedundantSensorDataCapture” attribute.

In step S13, the sensor data monitor 13 queries the EES 14 for the attributes of each EAS 12 for which transmission control is to be performed by that sensor data monitor 13. The EES 14 returns the attributes of the EAS 12 queried by the sensor data monitor 13 to that sensor data monitor 13. In this processing, the EAS 12-1 and the EAS 12-2 are the EASs 12 for which transmission control is to be performed by the sensor data monitor 13, and the sensor data monitor 13 obtains the attributes of the EAS 12-1 and the EAS 12-2.

In step S14, based on the result of the query, the sensor data monitor 13 transmits, to the EASs 12-1 and 12-2 for which transmission control is to be performed by the sensor data monitor 13, DVS data generation notifications instructing DVS data to be transmitted to the sensor data monitor 13, in the event that the DVS data has been generated. Based on the DVS data generation notification, the EASs 12-1 and 12-2 recognize that when DVS data is obtained, that DVS data may be transferred to the sensor data monitor 13.

In step S15, the EAC 23-1 of the user equipment 11-1 obtains the DVS data from the DVS sensor 21-1, and transmits the obtained DVS data to the EAS 12-1 that serves as the other part of the pair. In step S16, the EAC 23-2 of the user equipment 11-2 obtains the DVS data from the DVS sensor 21-2, and transmits the obtained DVS data to the EAS 12-2 that serves as the other part of the pair. The order of processing in steps S15 and S16 may be reversed.

In step S17, the EAS 12-1 obtains the DVS data from the EAC 23-1 and transfers that data to the sensor data monitor 13. In step S18, the EAS 12-2 obtains the DVS data from the EAC 23-2 and transfers that data to the sensor data monitor 13. The processing of step S17 may be performed after step S15, and is not related to the processing of step S16. Similarly, the processing of step S18 may be performed after step S16, and is not related to the processing of step S15.

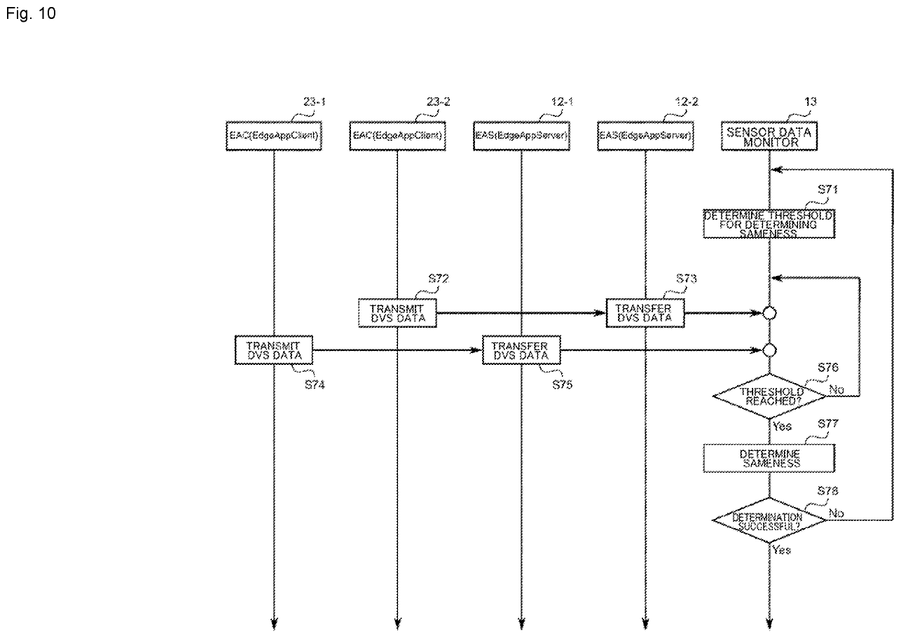

In step S19, the sensor data monitor 13 executes the sameness determination processing for determining the sameness of the DVS data transmitted from the EAC 23-1 via the EAS 12-1 and the DVS data transmitted from the EAC 23-2 via the EAS 12-2. The sameness determination processing will be described in detail later with reference to FIG. 10.

In step S20, the sensor data monitor 13 determines whether sameness has been detected from the result of the sameness determination processing.

In step S20, if it is determined that sameness has been detected, the sequence moves to step S21, where the sensor data monitor 13 selects one of the EAS 12-1 and the EAS 12-2 as targets for obtaining image frame data, and transmits an image frame data transmission off command to the EAS that is not selected. In other words, at present, the parameter “Allowed” in the attributes of the EAS 12-1 and the EAS 12-2 is “False”, and thus the image frame data may be obtained from one of the EAS 12-1 and the EAS 12-2 and transmitted to the recognition processing server 16. Accordingly, for example, the sensor data monitor 13 determines that the EAS 12-1 is to be selected as the target for image frame data obtainment, and transmits a transmission off command, for turning off the image frame data session, to the EAS 12-2. The transmission off command is transmitted to the EAC 23-2 via the EAS 12-2.

In step S22, the EAC 23-2 which has received the transmission off command from the sensor data monitor 13 turns the transmission of image frame data off such that no image frame data is transmitted to the EAS 12-2, even if image frame data has been obtained from the FIS 22-2.

In step S23, the EAC 23-2 of the user equipment 11-2, for which the transmission of image frame data has been turned off, transmits, to the EAS 12-2, only the DVS data among the DVS data and the image frame data supplied from the DVS sensor 21-2 and the FIS sensor 22-2, respectively. Then, in step S24, the EAS 12-2 transfers the DVS data transmitted from the EAC 23-2 to the sensor data monitor 13.

On the other hand, in step S25, the EAC 23-1 of the user equipment 11-1, for which the transmission of image frame data has not been turned off, transmits, to the EAS 12-1, the DVS data and the image frame data supplied from the DVS sensor 21-1 and the FIS sensor 22-1, respectively. Note that the DVS data and the image frame data are obtained at different timings, and thus each time the DVS data or the image frame data is obtained, the EAC 23-1 transmits the obtained data to the EAS 12-1.

In step S26, the EAS 12-1 transfers, to the sensor data monitor 13, the DVS data and the image frame data transmitted from the EAC 23-1. The DVS data and the image frame data are obtained at different timings, and thus the timings of the transfers differ as well.

In step S27, the sensor data monitor 13 obtains the DVS data and image frame data transmitted from the EAS 12-1, and transfers the image frame data to the recognition processing server 16. The DVS data transmitted from the EAC 23-1 and the EAC 23-2 are used by the sensor data monitor 13 to determine, for example, whether an object to be recognized is present.

In step S28, the recognition processing server 16 obtains the image frame data transmitted from the sensor data monitor 13, executes the predetermined recognition processing, and outputs a result thereof.

Meanwhile, although the processing performed when it is determined that sameness has not been detected in the above-described step S20 has not been described in detail, the subjects detected by the user equipment 11-1 and 11-2 are different, and thus the transmission off command for turning the image frame data session off is not transmitted. As a result, the image frame data shot by the user equipment 11-1 and 11-2, respectively, are transferred to the recognition processing server 16 via the sensor data monitor 13, and recognition processing is then executed for each piece of image frame data.

This completes the first transmission control processing by the image network system 1.

In the above-described step S21, which of the EAS 12-1 and the EAS 12-2 is to be selected for obtainment of the image frame data may be determined in advance, or may be selected as appropriate based on predetermined conditions. For example, when there are differences in the quality of the image frame data, such as when the FIS sensors 22 have different resolutions, the sensor data monitor 13 can select the EAS 12 for which the data has the highest quality.

<Attribute Registration Processing>

The attribute registration processing for the EAS 12, performed between each EAS 12 and EES 14 in step S12 in FIG. 8, will be described in detail with reference to the flowchart in FIG. 9.

First, in step S51, the EAS 12 obtains the specified attributes from the orchestrator The attributes obtained here are, for example, the “RedundantSensorDataCapture”, with a TargetEASGroupID parameter of “1” and an “Allowed” parameter of “False”.

In step S52, the EAS 12 transmits, to the EES 14, an attribute registration request for the EAS 12 to register its own attributes. The attribute registration request includes identification information identifying the EAS 12, and the “RedundantSensorDataCapture” attributes including the parameters.

In step S53, the EES 14 executes authentication processing for authenticating the EAS 12 that transmitted the attribute registration request, and when the authentication succeeds, the attributes of the EAS 12 are stored in internal memory.

Then, in step S54, the EES 14 transmits, to the EAS 12 that transmitted the attribute registration request, an attribute registration completion notification indicating that the attribute registration is complete, after which the attribute registration processing ends.

<Sameness Determination Processing>

The sameness determination processing performed in step S19 of FIG. 8 will be described in detail next with reference to the flowchart in FIG. 10.

First, in step S71, the sensor data monitor 13 determines a threshold for determining the sameness. In other words, as described above, the DVS data is generated at irregular intervals when events occur, and it is therefore necessary to determine the sameness of subjects between event data groups in which a given amount of event data have been accumulated. This threshold is a threshold for determining whether a given amount of event data sufficient for determining the sameness has been accumulated, and serves as a trigger for determining the sameness. The threshold may be determined according to the number of event data, or according to the accumulation time of the event data.

After the threshold determination in step S71, in step S72, the EAC 23-2 of the user equipment 11-2 obtains the DVS data from the DVS sensor 21-2, and transmits the obtained DVS data to the EAS 12-2 that serves as the other part of the pair. In step S73, the EAS 12-2 obtains the DVS data from the EAC 23-2 and transfers that data to the sensor data monitor 13.

In step S74, the EAC 23-1 of the user equipment 11-1 obtains the DVS data from the DVS sensor 21-1, and transmits the obtained DVS data to the EAS 12-1 that serves as the other part of the pair. In step S75, the EAS 12-1 obtains the DVS data from the EAC 23-1 and transfers that data to the sensor data monitor 13.

The processing from steps S72 to S75 is the same as the processing from steps S15 to S18 in FIG. 8.

In step S76, the sensor data monitor 13 determines whether the number or time of the obtained DVS data has reached the threshold determined in step S71. The processing of step S76 is repeated until the number or time of the obtained DVS data is determined to have reached the threshold. Through this, the DVS data is accumulated until the number or time of the obtained DVS data reaches the threshold determined in step S71.

When it is determined in step S76 that the number or time of the DVS data has reached the threshold, the sequence moves to step S77, where the sensor data monitor 13 determines the sameness of the subjects using the DVS data.

Any method can be used to determine the sameness of the subjects using DVS data, but the following method can be used, for example.

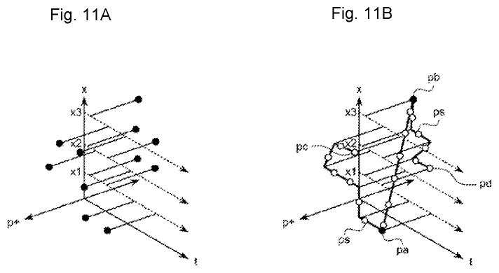

The sensor data monitor 13 maps a predetermined number of event data groups transmitted from the user equipment 11 as DVS data to a three-dimensional space having an x axis, a p axis, and a t axis, focusing only on the x coordinates, as indicated by A in FIG. 11. Then, among a p+ point group and a p− point group in the three-dimensional space, two points, namely a point pa and a point pb, having the greatest distance therebetween, are determined and connected by a straight line, as indicated by B in FIG. 11. The sensor data monitor 13 sequentially obtains adjacent points where the distance from the point pa to the p+ point group is the shortest and connects all the p+ point group with straight lines, and similarly, sequentially obtains adjacent points where the distance from the point pb to the p− point group is the shortest and connects all the p− point group with straight lines. Next, the sensor data monitor 13 determines a plurality of representative points ps expressing a three-dimensional shape (linear shape) of the event data group by evenly dividing a straight line connecting an end point pc on the p+ side to an end point pd on the p− side using a predetermined number of points ps.

For the DVS data of each of the plurality of pieces of user equipment 11 to be compared, the similarity of the three-dimensional shapes is calculated using the plurality of representative points ps determined as described above, and if the similarity is less than or equal to a predetermined threshold, the subjects can be determined to be the same, whereas if the similarity is greater than the predetermined threshold, the subjects can be determined to be different. The similarity can be, for example, an average of the distances between representative points ps corresponding to each of the plurality of pieces of user equipment 11.

Although the foregoing describes an example in which only the x coordinates in the event data group are focused on, the similarity can also be calculated by focusing on the y coordinates and using both the x coordinates and the y coordinates. Additionally, the similarity may also be determined using the three-dimensional shape sameness determination method disclosed in http://www.cvg.ait.kyushu-u.ac.jp/papers/2007_2009/5-1/9-M_033.pdf, a determination method using a Euclidean distance of N-dimensional vectors, or the like.

In step S78 in FIG. 10, the sensor data monitor 13 determines whether sameness has been successfully determined in the sameness determination processing. For example, if in step S78 a confidence level of the sameness determination is less than or equal to a predetermined value and sameness could therefore not be determined, the sequence returns to step S71 and the above-described processing is repeated. In other words, the threshold for determining sameness is changed, and the sameness determination is performed again after continuously accumulating DVS data.

On the other hand, if in step S78 it is determined that sameness has been determined successfully, the sameness determination processing ends, and the sequence moves to step S20 in FIG. 8.

According to the first transmission control processing described above, the sensor data monitor 13 determines the sameness of subjects based on DVS data accumulated to at least a predetermined threshold, and based on the result of the determination, whether to transmit the image frame data from only one of the user equipment 11-1 and 11-2 to the recognition processing server 16 is controlled. Specifically, when the subjects are determined to be the same, the sensor data monitor 13 transmits only the image frame data shot by one FIS sensor 22 to the recognition processing server 16. This limits the flow of image frame data to the network, which makes it possible to reduce traffic on the network and reduce the load on the authentication processing application in the cloud server.

<4. Second Transmission Control Processing of Image Frame Data>

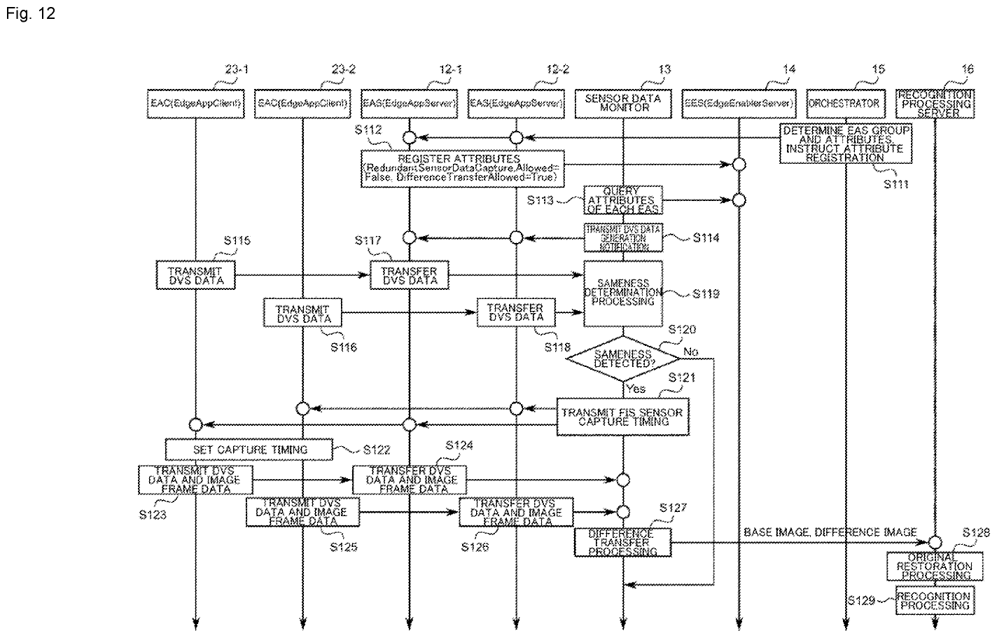

Second transmission control processing executed by the image network system 1, which is transmission control processing for transmitting a difference in the image frame data based on the result of the subject sameness determination processing performed using the DVS data, will be described next with reference to the flowchart in FIG. 12. The processing in FIG. 12 is started, for example, when an authentication processing service using image frame data is instructed to start.

First, in step S111, the orchestrator 15 determines the group to which each EAS 12 belongs and the attributes thereof based on the service requirement conditions, supplies the determined group and attributes to each EAS 12, and instructs the registration of the attributes.

Similar to the above-described first transmission control processing, in the second transmission control processing, the “RedundantSensorDataCapture” attributes including the parameters TargetEASGroupID and Allowed are determined and instructed to each EAS 12. Accordingly, in the second transmission control processing too, “attribute” refers to the “RedundantSensorDataCapture” attribute. Furthermore, in the second transmission control processing, a sub-parameter DifferenceTransferAllowed, which is valid only when the parameter Allowed is False, is added.

The sub-parameter DifferenceTransferAllowed takes a logical value of True or False. When the sub-parameter DifferenceTransferAllowed is False, processing similar to the above-described first transmission control processing is performed, i.e., only one piece of image frame data among the plurality of pieces of image frame data shot of the same subject is transferred to the recognition processing server 16. On the other hand, when the sub-parameter DifferenceTransferAllowed is True, one piece of the image frame data is taken as a base, and that image frame data taken as a base (called “base image frame data” hereinafter) and difference image frame data that is a difference from that base image frame data are transferred to the recognition processing server 16. The sub-parameter DifferenceTransferAllowed is False by default. The example in FIG. 12 assumes that the EAS 12-1 and the EAS 12-2 are assigned to the same group (e.g., TargetEASGroupID=“1”), and that “RedundantSensorDataCapture.Allowed=False” and “DifferenceTransferAllowed=True” are specified.

In step S112, the EAS 12-1 and the EAS 12-2 each obtain an attribute registration instruction from the orchestrator 15 and register their own attribute in the EES 14.

The processing from steps S113 to S120 is the same as the processing from steps S13 to S20 in the first transmission control processing in FIG. 8, and will therefore not be described.

Then, in step S120, if it is determined that sameness has been detected, the sequence moves to step S121, where the sensor data monitor 13 calculates deviation between the system clocks of the user equipment 11-1 and 11-2 based on the correspondence relationship between the DVS data supplied from the EAS 12-1 and the EAS 12-2, respectively, and determines a capture timing at which the FIS sensors 22 capture at the same absolute time. The sensor data monitor 13 transmits the determined capture timings of the FIS sensors 22 to the EACs 23 of the user equipment 11-1 and 11-2, respectively, via the EASs 12.

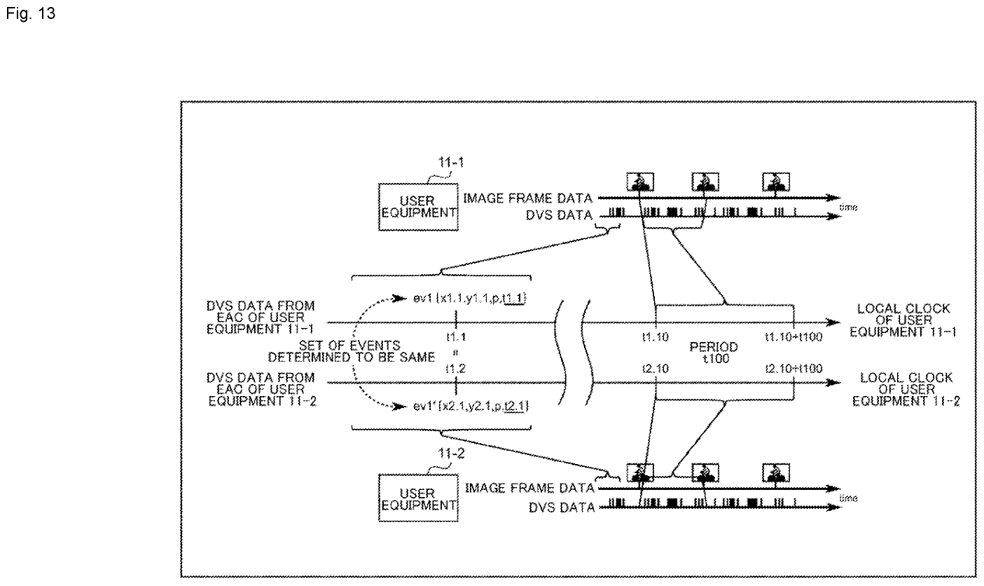

FIG. 13 is a diagram illustrating the determination of the capture timing in step S121.

The sameness determination processing is executed in the above-described step S119, and thus the event data supplied from the DVS sensors 21-1 and 21-2, respectively, are in correspondence. For example, assume that as illustrated in FIG. 13, event data ev1 (x1.1,y1.1,p,t1.1) from the DVS sensor 21-1 of the user equipment 11-1 and event data ev1′ (x2.1,y2.1,p,t2.1) from the DVS sensor 21-2 of the user equipment 11-2 are in correspondence. In this case, it can be seen that a local clock value t1.1 of the user equipment 11-1 and a local clock value t2.1 of the user equipment 11-2 are in correspondence. Note that the clock period of the system clock of each piece of user equipment 11 is the same.

The sensor data monitor 13 specifies a capture timing to the FIS 22-1 of the user equipment 11-1 such that image frames are shot at a period t100 from time t1.10, and specifies a capture timing to the FIS 22-2 of the user equipment 11-2 such that image frames are shot at a period t100 from time t2.10. In this manner, the sensor data monitor 13 calculates deviation between the system clocks of the user equipment 11-1 and 11-2, and specifies, as the capture timing, a capture start time and a frame period at which the absolute times are the same.

Returning to FIG. 12, in step S122, the EAC 23 of each piece of user equipment 11 obtains the capture timing transmitted from the sensor data monitor 13 and sets that capture timing in the FIS sensor 22.

In step S123, the EAC 23-1 of the user equipment 11-1 transmits, to the EAS 12-1, the DVS data and the image frame data supplied from the DVS sensor 21-1 and the FIS sensor 22-1, respectively. In step S124, the EAS 12-1 transfers, to the sensor data monitor 13, the DVS data and the image frame data transmitted from the EAC 23-1. Although the DVS data and the image frame data are obtained at different timings in the user equipment 11-1, these timings are illustrated together for the sake of simplicity.

In step S125, the EAC 23-2 of the user equipment 11-2 transmits, to the EAS 12-2, the DVS data and the image frame data supplied from the DVS sensor 21-2 and the FIS sensor 22-2, respectively. In step S126, the EAS 12-2 transfers, to the sensor data monitor 13, the DVS data and the image frame data transmitted from the EAC 23-2. Although the DVS data and the image frame data are obtained at different timings in the user equipment 11-2 too, these timings are illustrated together for the sake of simplicity.

In step S127, the sensor data monitor 13 obtains the DVS data and the image frame data transmitted from the EASs 12-1 and 12-2, respectively. Then, the sensor data monitor 13 executes differential transfer processing for calculating a difference between the image frame data transmitted from the two EASs 12-1 and 12-2, and transmitting the base image frame data and the difference image frame data to the recognition processing server 16. To be more specific, the sensor data monitor 13 takes, as a base, one of the pieces of image frame data transmitted from the EASs 12-1 and 12-2, e.g., the image frame data from the EAS 12-1, and calculates a difference between that image frame data from the EAS 12-1 and the image frame data from the EAS 12-2. The difference image frame data calculated as the difference, and the base image frame data from the EAS 12-1 that was taken as the base, are then transferred to the recognition processing server 16.

In step S128, the recognition processing server 16 obtains the base image frame data and the difference image frame data transmitted from the sensor data monitor 13. Using the base image frame data and the difference image frame data, the recognition processing server 16 executes original restoration processing and restores the image frame data of the EAS 12-2, which was sent as a difference.

Furthermore, in step S129, the recognition processing server 16 executes predetermined recognition processing on the image frame data from the user equipment 11-1, which serves as the base image frame data, and the restored image frame data from the user equipment 11-2, and outputs a result of the recognition processing.

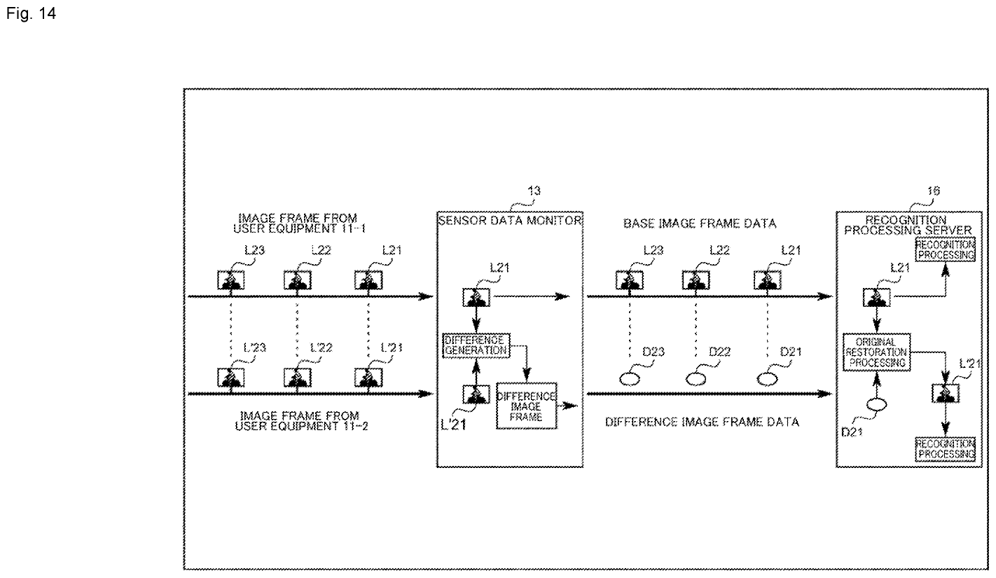

FIG. 14 is a diagram illustrating the differential transfer processing and the original restoration processing.

For example, images L21, L22, and L23 shot by the FIS 22-1 of the user equipment 11-1 are transmitted to the sensor data monitor 13 in sequence. Similarly, images L′21, L′22, and L′23 shot by the FIS 22-2 of the user equipment 11-2 are transmitted to the sensor data monitor 13 in sequence.

The sensor data monitor 13 calculates a difference between the image L21 and the image L′21, generates difference data D21 of the image L′21 relative to the image L21, and transmits that data to the recognition processing server 16. Similarly, difference data D22 of the image L′22 relative to the image L22 and difference data D23 of the image L′23 relative to the image L23 are generated in sequence and transmitted to the recognition processing server 16.

The recognition processing server 16 generates the original image L′21 from the obtained image L21 and difference data D21. Similarly, the original image L′22 is generated from the image L22 and the difference data D22, and the original image L′23 is generated from the image L23 and the difference data D23. The recognition processing is then executed in sequence on the images L21, L22, and L23 shot by the FIS 22-1 of the user equipment 11-1, and the recognition processing is executed in sequence on the images L′21, L′22, and L′23 shot by the FIS 22-2 of the user equipment 11-2.

This completes the second transmission control processing by the image network system 1.

According to the second transmission control processing described above, the sensor data monitor 13 determines the sameness of subjects based on the DVS data, and if the subjects are determined to be the same, the sensor data monitor 13 transmits the image frame data shot by one piece of user equipment 11 to the recognition processing server 16 as-is as the base image frame data, and transmits the image frame data shot by the other piece of user equipment 11 to the recognition processing server 16 as difference image frame data. This limits the flow of image frame data to the network, which makes it possible to reduce traffic on the network.

<5. Third Transmission Control Processing of Image Frame Data>

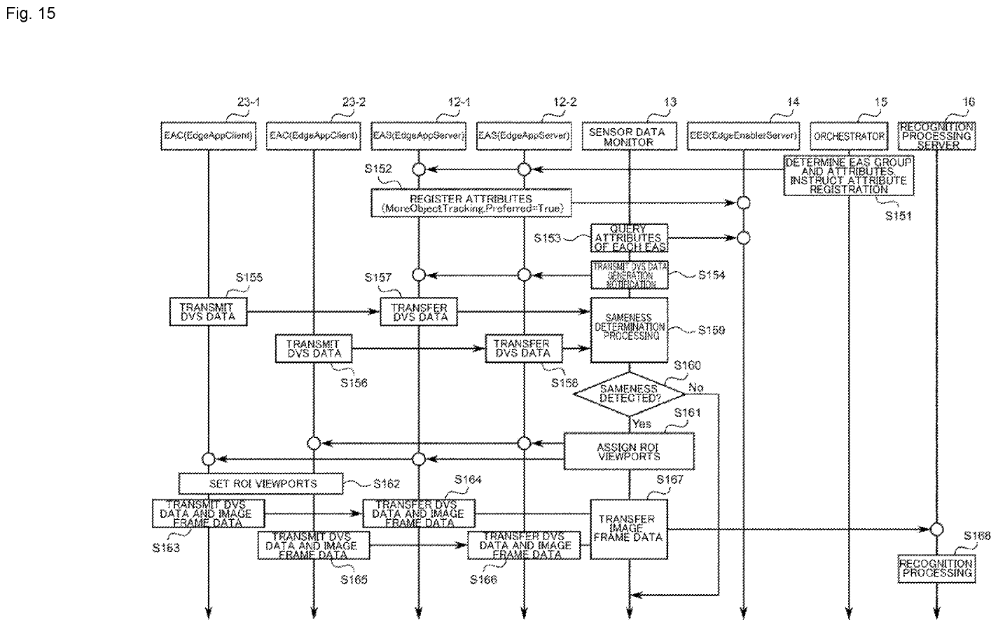

Third transmission control processing executed by the image network system 1, which is transmission control processing in which, when a plurality of (at least two) subjects are present in a capturing range at the same time, image frame data in which ROI viewports are assigned to different subjects between the user equipment 11 is transmitted, will be described next with reference to the flowchart in FIG. 15. Here, “ROI viewport” refers to a viewport (display area), among a plurality of viewports obtained by dividing the overall capturing range of an FIS sensor 22, which is taken as an area of interest and assigned a greater number of pixels (a higher resolution) than the other viewports.

The processing in FIG. 15 is started, for example, when an authentication processing service using image frame data is instructed to start.

First, in step S151, the orchestrator 15 determines the group to which each EAS 12 belongs and the attributes thereof based on the service requirement conditions, supplies the determined group and attributes to each EAS 12, and instructs the registration of the attributes.

In the third transmission control processing, the orchestrator 15 determines “MoreObjectTracking” as an application attribute (extended attribute) of the EAS 12. The “MoreObjectTracking” attribute has TargetEASGroupID and Preferred as parameters.

The parameter TargetEASGroupID takes an integer value, and expresses a number indicating the group to which EAS 12 belongs. The parameter Preferred takes a logical value of True or False. The parameter Preferred being True indicates adjustment of the image frame data such that EASs 12 designated by the TargetEASGroupID avoid capturing the same subject to the greatest extent possible. Conversely, the parameter Preferred being False indicates that such subject adjustment is not to be performed. The parameter Preferred is True by default. The example in FIG. 15 assumes that the EAS 12-1 and the EAS 12-2 are assigned to the same group (e.g., TargetEASGroupID=“1”), and that “MoreObjectTracking.Preferred=True” is specified.

In step S152, the EAS 12-1 and the EAS 12-2 each obtain an attribute registration instruction from the orchestrator 15 and register their own “MoreObjectTracking” attribute in the EES 14. The EES 14 stores the “MoreObjectTracking” attribute of each EAS 12 as communicated by each EAS 12. Below, in the third transmission control processing, “attribute” refers to the “MoreObjectTracking” attribute.

The processing from steps S153 to S160 is the same as the processing from steps S13 to S20 in the first transmission control processing in FIG. 8, and will therefore not be described. It is assumed that in the DVS data subjected to the sameness determination, two subjects appear simultaneously in the capturing range.

If sameness is determined to have been detected in step S160, the sequence moves to step S161, where the sensor data monitor 13 assigns different ROI viewports to the FIS sensor 22 of the user equipment 11-1 and the FIS sensor 22-2 of the user equipment 11-2, for the two subjects appearing simultaneously in the capturing range.

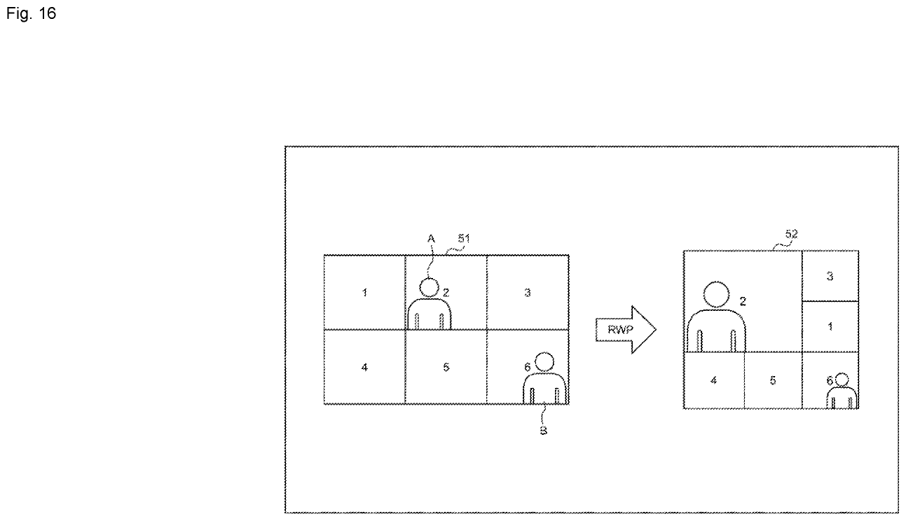

For example, the FIS sensor 22 has a capturing range 51 indicated in FIG. 16, and that capturing range 51 is divided into six parts, namely areas 1 to 6, as indicated in FIG. 16. Assume that two subjects A and B appear simultaneously in the capturing range 51 of the FIS sensor 22, with the subject A present in the area 2 and the subject B present in the area 6.

For example, the sensor data monitor 13 assigns, to the FIS sensor 22-1 of the user equipment 11-1, an ROI viewport such that a packing image 52, in which the area 2 where the subject A is present has a higher resolution, is generated, as indicated on the right side of FIG. 16. On the other hand, the sensor data monitor 13 assigns, to the FIS sensor 22-2 of the user equipment 11-2, an ROI viewport such that a packing image 52, in which the area 6 where the subject B is present has a higher resolution, is generated (not shown). Region-wise packing is known as packing image generation processing in which a greater number of pixels (a higher resolution) is assigned to a subject of interest in this manner (see, for example, “ISO/IEC 23090-2: Information technology—Coded representation of immersive media—Part 2: Omnidirectional media format”).

Returning to FIG. 15, in step S161, the sensor data monitor 13 transmits, to the EACs 23-1 and 23-2 via the EASs 12-1 and 12-2, ROI viewport control information which assigns ROI viewports to different subjects between the FIS sensor 22 of the user equipment 11-1 and the FIS sensor 22-2 of the user equipment 11-2.

In step S162, each of the EACs 23-1 and 23-2 sets the ROI viewport based on the ROI viewport control information from the sensor data monitor 13.

In step S163, the EAC 23-1 of the user equipment 11-1 transmits, to the EAS 12-1, the DVS data and the image frame data supplied from the DVS sensor 21-1 and the FIS sensor 22-1, respectively. In step S164, the EAS 12-1 transfers, to the sensor data monitor 13, the DVS data and the image frame data transmitted from the EAC 23-1. Although the DVS data and the image frame data are obtained at different timings in the user equipment 11-1, these timings are illustrated together for the sake of simplicity.

On the other hand, in step S165, the EAC 23-2 of the user equipment 11-2 transmits, to the EAS 12-2, the DVS data and the image frame data supplied from the DVS sensor 21-2 and the FIS sensor 22-2, respectively. In step S166, the EAS 12-2 transfers, to the sensor data monitor 13, the DVS data and the image frame data transmitted from the EAC 23-2. Although the DVS data and the image frame data are obtained at different timings in the user equipment 11-2 too, these timings are illustrated together for the sake of simplicity.

In step S167, the sensor data monitor 13 obtains the DVS data and image frame data transmitted from the EAS 12-1, and transfers the image frame data to the recognition processing server 16. Also, in step S167, the sensor data monitor 13 obtains the DVS data and image frame data transmitted from the EAS 12-2, and transfers the image frame data to the recognition processing server 16. In other words, a plurality of pieces of image frame data assigned to different ROI viewports among the pieces of user equipment 11 are transferred from the sensor data monitor 13 to the recognition processing server 16.

In step S168, the recognition processing server 16 obtains the two types of image frame data transmitted from the sensor data monitor 13, executes the predetermined recognition processing on each, and outputs a result thereof. The image frame data obtained by the user equipment 11-1 is, for example, the packing image 52 in which, in the example in FIG. 16, the area 2 where the subject A is present has a higher resolution, and the image frame data obtained by the user equipment 11-2 is the packing image 52 in which the area 6 where the subject B has a higher resolution is present.

This completes the third transmission control processing by the image network system 1.

According to the third transmission control processing described above, when a plurality of (at least two) subjects are present simultaneously in the capturing ranges of the user equipment 11, and those subjects are captured simultaneously by the plurality of pieces of user equipment 11, image frame data is generated in which ROI viewports are assigned to different subjects between the pieces of user equipment 11, and that image frame data is transmitted to the recognition processing server 16. This makes it possible to perform recognition processing, analysis processing, and the like while capturing a greater number of objects simultaneously at high resolution.

The image network system 1 can select and execute the above-described first to third transmission control processing as appropriate according to the service requirement conditions.

<6. Block Diagram>

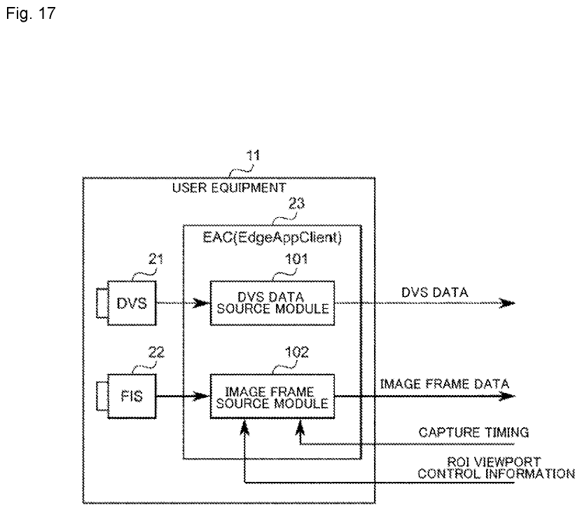

FIG. 17 is a detailed block diagram of the user equipment 11.

The user equipment 11 includes the DVS sensor 21, the FIS sensor 22, and the EAC 23. Descriptions of the DVS sensor 21 and the FIS sensor 22 will not be repeated. The EAC 23 includes a DVS data source module 101 and an image frame source module 102 as control units that control the DVS data and the image frame data.

The DVS data source module 101 transmits, to the EAS 12, the DVS data, which is output from the DVS sensor 21 at an arbitrary timing.

The image frame source module 102 transmits, to the EAS 12, the image frame data, which is output from the FIS sensor 22 in units of frames. The image frame source module 102 also obtains the capture timing transmitted from the sensor data monitor 13 via the EAS 12, and sets the capture timing in the FIS sensor 22. Based on the ROI viewport control information transmitted from the sensor data monitor 13 via the EAS 12, the image frame source module 102 generates a packing image such that the assigned ROI viewport has a higher resolution.

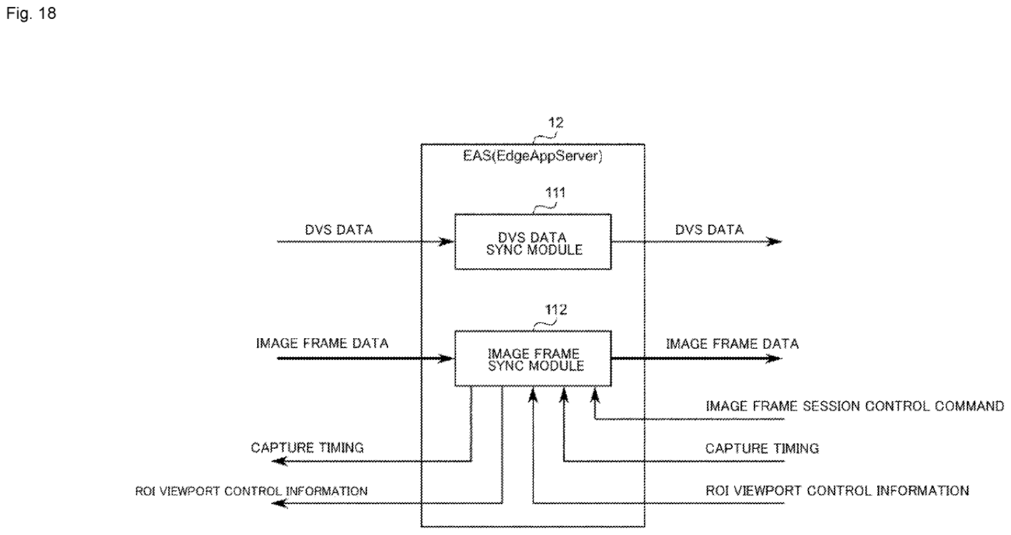

FIG. 18 is a detailed block diagram of the EAS 12.

The EAS 12 includes a DVS data sync module 111 and an image frame sync module 112 as control units that control the DVS data and the image frame data.

The DVS data sync module 111 obtains the DVS data from the DVS data source module 101 of the EAC 23 and transmits that data to the sensor data monitor 13.

The image frame sync module 112 obtains the image frame data from the image frame source module 102 of the EAC 23 and transmits that data to the sensor data monitor 13.

Additionally, in the first transmission control processing, the image frame sync module 112 performs control for turning the transmission of the image frame data on or off based on an image frame session control command that controls the image frame data session. The image frame session control command includes a transmission on command for turning the transmission of the image frame data on, and the transmission off command for turning the transmission of the image frame data off.

Furthermore, in the second transmission control processing, the image frame sync module 112 obtains the capture timing transmitted from the sensor data monitor 13, and transmits the capture timing to the image frame source module 102 of the EAC 23.

In the third transmission control processing, the image frame sync module 112 obtains the ROI viewport control information transmitted from the sensor data monitor 13, and transmits that information to the image frame source module 102 of the EAC 23.

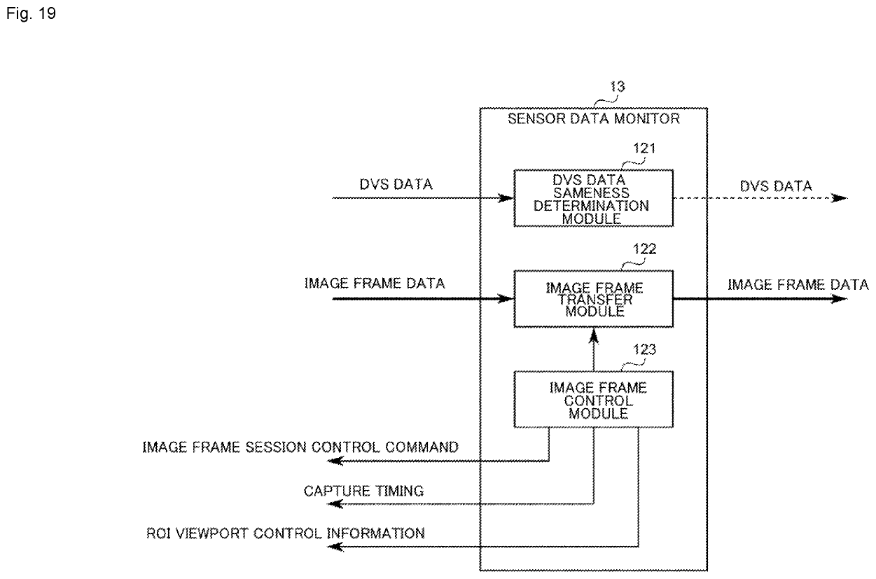

FIG. 19 is a detailed block diagram of the sensor data monitor 13.

The sensor data monitor 13 includes a DVS data sameness determination module 121, an image frame transfer module 122, and an image frame control module 123 as control units that control the DVS data and the image frame data.

The DVS data sameness determination module 121 executes the sameness determination processing for determining the sameness of the DVS data transmitted from the plurality of pieces of user equipment 11. Determining the sameness of the DVS data means determining the sameness of the subjects. In the examples of the first to third transmission control processing described above, the DVS data is not transmitted to the recognition processing server 16, but if necessary, the DVS data may be transmitted to the recognition processing server 16 in the same manner as the image frame data.

Under the control of the image frame control module 123, the image frame transfer module 122 performs predetermined processing on the image frame data transmitted from each of the plurality of pieces of user equipment 11 as necessary, and transmits the results thereof to the recognition processing server 16.

Specifically, in the first transmission control processing, the image frame transfer module 122 transmits, as-is to the recognition processing server 16, the image frame data transmitted from the user equipment 11. In the second transmission control processing, the image frame transfer module 122 generates the base image frame data and the difference image frame data from the image frame data transmitted from the plurality of pieces of user equipment 11, and transmits the generated data to the recognition processing server 16. In the third transmission control processing, the image frame transfer module 122 transmits, as-is to the recognition processing server 16, the image frame data having different ROI viewports, transmitted from each of the plurality of pieces of user equipment 11.

The image frame control module 123 performs control pertaining to the image frame data. Specifically, in the first transmission control processing, the image frame control module 123 transmits, to the image frame sync module 112 of the EAS 12, an image frame session control command which turns the transmission of the image frame data on or off, based on a result of the sameness determination processing performed by the DVS data sameness determination module 121.

In the second transmission control processing, the image frame control module 123 calculates deviation between the system clocks of the user equipment 11-1 and 11-2 based on the correspondence relationship of the DVS data, determines the capture timings for capturing at the same timing, and transmits the capture timings to the image frame sync module 112 of the EAS 12. The image frame control module 123 instructs the image frame transfer module 122 to generate the difference image frame data.

In the third transmission control processing, the image frame control module 123 generates ROI viewport control information which assigns ROI viewports to different subjects between the FIS sensor 22 of the user equipment 11-1 and the FIS sensor 22-2 of the user equipment 11-2, and transmits that information to the image frame sync module 112 of the EAS 12.

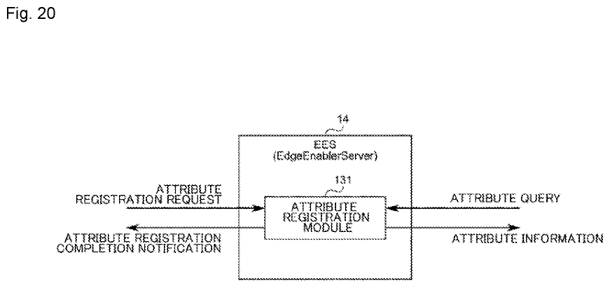

FIG. 20 is a detailed block diagram of the EES 14.

The EES 14 includes an attribute registration module 131 as a control unit that controls the attribute registration.

The attribute registration module 131 executes authentication processing based on the attribute registration request from the EAS 12. If the authentication succeeds, the attribute registration module 131 stores the attributes of the EAS 12 in the internal memory, and transmits an attribute registration completion notification indicating that the attribute registration is complete to the EAS 12 as a response to the request.

Additionally, the attribute registration module 131 returns the attribute information of the EAS 12 to the sensor data monitor 13 in response to the attribute query made by the sensor data monitor 13 to each EAS 12.

<7. Example of Transmission Formats of Event Data and Image Frame Data>

The data formats used when transmitting the event data and the image frame data will be described next.

The event data is transmitted to the recognition processing server 16 from the EAC 23 of the user equipment 11 as an event stream constituted by an event packet group including at least one event packet.

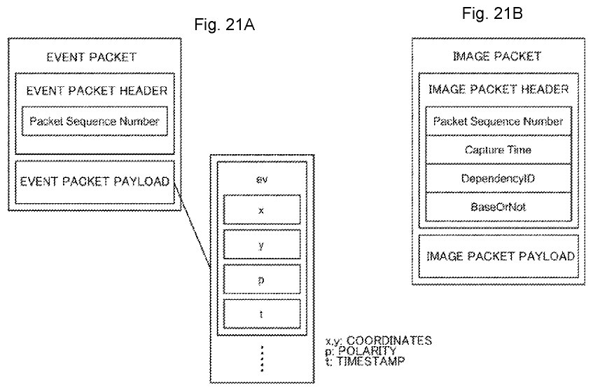

A in FIG. 21 is a diagram illustrating the format of the event packets in which the event data is stored.

Each event packet is constituted by an event packet header and an event packet payload. The event packet header includes at least a Packet Sequence Number. The Packet Sequence Number is a sequence number, unique to that transport session, which is assigned for each event packet payload. The Packet Sequence Number is periodically reset to 0 at a sufficient length.

The event packet payload stores a plurality of pieces of event data in, for example, the AER format, represented by “ev” in the above-described Formula (1).

Note that the format of the event data stored in the event packet payload is not limited to the AER format, and may be in a different format instead.

The image frame data is transmitted to the recognition processing server 16 from the EAC 23 of the user equipment 11 as an image stream constituted by an image packet group including at least one image packet.

B in FIG. 21 is a diagram illustrating the format of the image packets in which the image frame data is stored.

Each image packet includes an image packet header and an image packet payload. The image packet header includes at least a Packet Sequence Number, a Capture Time, a DependencyID, and BaseOrNot. The Packet Sequence Number is a sequence number, unique to that transport session, which is assigned for each image packet payload. The Packet Sequence Number is periodically reset to 0 at a sufficient length. Capture Time indicates the time of a local clock when the image was captured. DependencyID is an identifier for establishing correspondence between the base image frame data and the difference image frame data in the second transmission control processing for transmitting difference image frame data, and the same number is stored for the base image frame data and the difference image frame data. BaseOrNot is an identifier for identifying the base image frame data and the difference image frame data in the second transmission control processing for transmitting difference image frame data. BaseOrNot=“True” is stored when the data stored in the image packet payload is the base image frame data, whereas BaseOrNot=“False” is stored when the data stored in the image packet payload is the difference image frame data.

The frame-based image data obtained by the FIS sensor 22 is divided and stored in image format in the image packet payload.

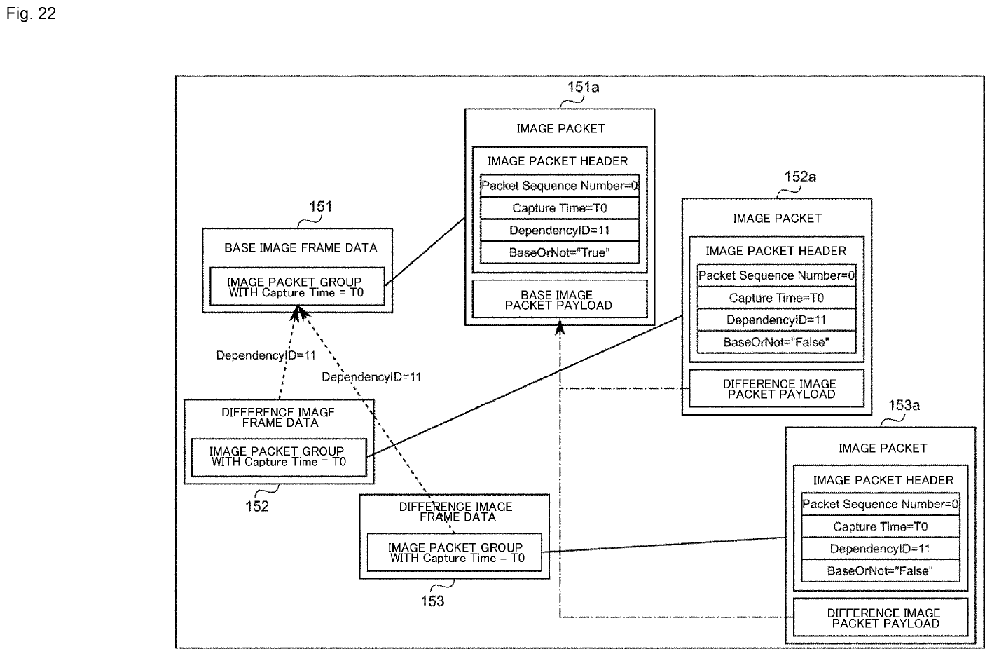

FIG. 22 illustrates an example of image packet data, indicating a correspondence relationship between the base image frame data and the difference image frame data.

Base image frame data 151, and difference image frame data 152 and 153, are image frame data output from (the EACs 23 of) the user equipment 11 belonging to the same group. The base image frame data 151, and the difference image frame data 152 and 153, are each established and transmitted as different sessions.

FIG. 22 illustrates, in detail, a predetermined single image packet having a Capture Time of TO, among the base image frame data 151 and the difference image frame data 152 and 153.

Packet Sequence Number=0, Capture Time=T0, DependencyID=11, and BaseOrNot=“True” are stored in the image packet header of a predetermined single image packet 151a having a Capture Time of T0 in the base image frame data 151.

Packet Sequence Number=0, Capture Time=T0, DependencyID=11, and BaseOrNot=“False” are stored in the image packet header of a predetermined single image packet 152a having a Capture Time of TO in the difference image frame data 152.

Packet Sequence Number=0, Capture Time=TO, DependencyID=11, and BaseOrNot=“False” are stored in the image packet header of a predetermined single image packet 153a having a Capture Time of TO in the difference image frame data 153.

From this, it can be seen that the image packets 151a, 152a, and 153a are all image data having a Capture Time of TO, and are base image frame data or difference image frame data from an identical group sharing the DependencyID of “11”. Furthermore, it can be seen that the image packet 151a for which BaseOrNot is “True” is a packet storing the image data of a base image, and the image packets 152a and 153a for which BaseOrNot is “False” are packets storing the image data of difference images.

<8. Other Control Examples>

The foregoing embodiment described control in which each EAS 12 transfers the image frame data obtained from the corresponding EAC 23 to the sensor data monitor 13, and the sensor data monitor 13 then transfers the obtained image frame data to the recognition processing server 16 based on the determination result from the sameness determination processing, as illustrated in FIG. 7.

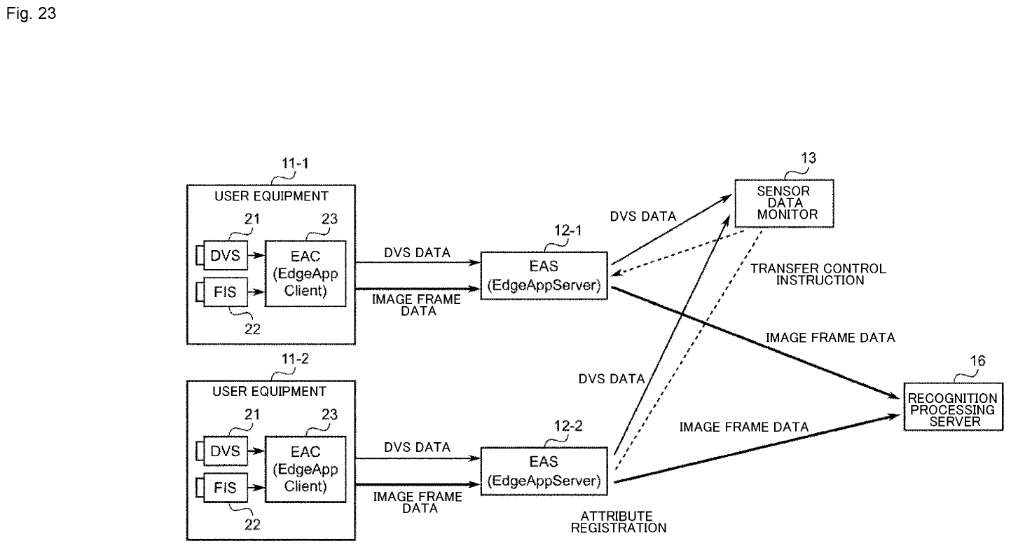

However, for example, each EAS 12 may transmit the obtained image frame data directly to the recognition processing server 16, without going through the sensor data monitor 13, as illustrated in FIG. 23.

In this case, in the above-described first transmission control processing, the sensor data monitor 13 instructs each EAS 12 to determine whether the EAS 12 is to transfer the image frame data to the recognition processing server 16 based on the determination result from the sameness determination processing. Each EAS 12 transmits the image frame data obtained from the corresponding EAC 23 to the recognition processing server 16 when transfer to the recognition processing server 16 has been instructed by a transfer control instruction from the sensor data monitor 13, but does not transmit the image frame data to the recognition processing server 16 when such an instruction has not been made.

If the image frame data has already been transmitted from each EAS 12 due to the timing of the transfer control, network devices along the path between the EAS 12 and the recognition processing server 16 may be instructed to stop the transfer such that the transfer to the recognition processing server 16 is stopped.

In the above-described second transmission control processing, the sensor data monitor 13 instructs each EAS 12 as to which of the base image frame data or the difference image frame data is to be transferred to the recognition processing server 16 based on the determination result from the sameness determination processing. The EAS 12 instructed to transfer the difference image frame data is notified of where the base image frame data is to be obtained from (a predetermined EAS 12). The EAS 12 instructed to transfer the base image frame data transmits the image frame data obtained from the corresponding EAC 23 as-is to the recognition processing server 16. The EAS 12 instructed to transfer the difference image frame data obtains the base image frame data from the predetermined EAS 12 notified as being where the base image frame data is to be obtained from, calculates a difference from its own image frame data, and transfers the calculated difference image frame data to the recognition processing server 16.

In the above-described third transmission control processing, the sensor data monitor 13 instructs each EAS 12 to transfer image frame data for which the ROI viewport is different from the other user equipment 11. Each EAS 12 transmits image frame data having a predetermined ROI viewport, obtained from the corresponding EAC 23, to the recognition processing server 16 directly, under the control of the sensor data monitor 13. As a result, image frame data having a different ROI viewport for each EAS 12 is transferred to the recognition processing server 16 from each EAS 12.

Similar to the case where the DVS data is transmitted to the recognition processing server 16, each EAS 12 can transmit the DVS data to the recognition processing server 16 based on a transfer control instruction from the sensor data monitor 13.

<9. Example of Configuration of Computer>

The above-described series of processing can also be executed by hardware or software. In the case where the series of processing is executed by software, a program that configures the software is installed on a computer. Here, the computer includes a microcomputer embedded in dedicated hardware or includes, for example, a general-purpose personal computer in which various functions can be executed by installing various programs.

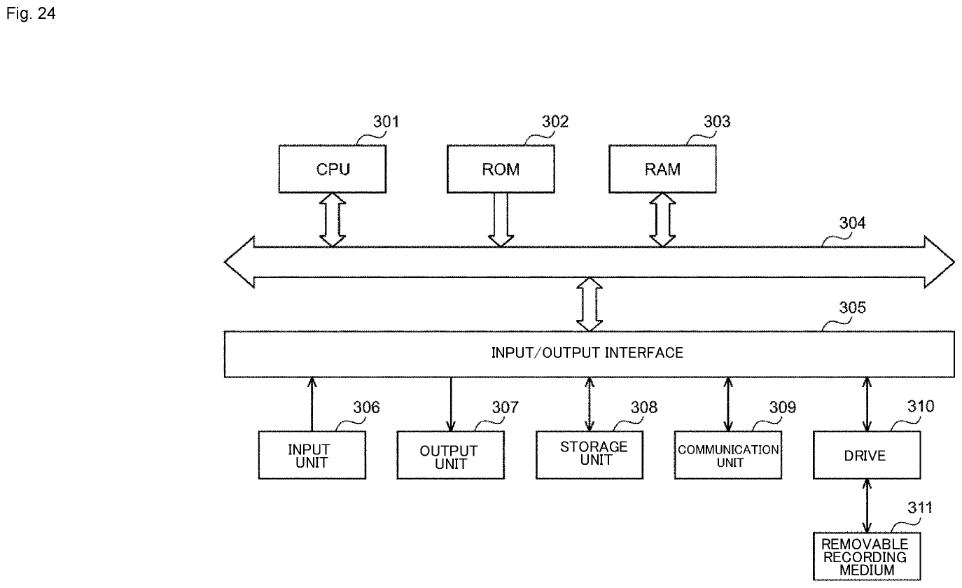

FIG. 24 is a block diagram illustrating an example of hardware configuration of a computer that executes the series of processing described above according to a program.

In the computer, a central processing unit (CPU) 301, read-only memory (ROM) 302, and random access memory (RAM) 303 are connected to each other by a bus 304.

An input/output interface 305 is further connected to the bus 304. An input unit 306, an output unit 307, a storage unit 308, a communication unit 309, and a drive 310 are connected to the input/output interface 305.

The input unit 306 includes a keyboard, a mouse, a microphone, a touch panel, an input terminal, and the like. The output unit 307 includes a display, a speaker, an output terminal, and the like. The storage unit 308 includes a hard disk, a RAM disk, non-volatile memory, and the like. The communication unit 309 is a network interface or the like. The drive 310 drives a removable recording medium 311 such as a magnetic disk, an optical disc, a magneto-optical disk, a semiconductor memory, or the like.

In the computer configured as described above, for example, the CPU 301 performs the above-described series of processing by loading a program stored in the storage unit 308 to the RAM 303 via the input/output interface 305 and the bus 304 and executing the program, for example. Data and the like necessary for the CPU 301 to execute the various kinds of processing is also stored as appropriate in the RAM 303.

The program executed by the computer (the CPU 301) can be recorded on, for example, the removable recording medium 311, as a packaged medium, and provided in such a state. The program can also be provided over a wired or wireless transmission medium such as a local area network, the Internet, or digital satellite broadcasting.

In the computer, by mounting the removable recording medium 311 in the drive 310, the program can be installed in the storage unit 308 through the input/output interface 305. The program can be received by the communication unit 309 via a wired or wireless transfer medium to be installed in the storage unit 308. In addition, the program may be installed in advance in the ROM 302 or the storage unit 308.

Note that the program executed by the computer may be a program in which the processing is performed chronologically in the order described in the present specification, or may be a program in which the processing is performed in parallel or at a necessary timing such as when called.

Note that in the present specification, the steps indicated in each flowchart may of course be performed in time series according to the order described therein, but need not absolutely be performed in time series, and may instead be performed in parallel or at the required timing, such as when called.

Note that, in the present specification, “system” means a set of a plurality of constituent elements (devices, modules (components), or the like), and it does not matter whether or not all the constituent elements are provided in the same housing. Therefore, a plurality of devices contained in separate housings and connected over a network, and one device in which a plurality of modules are contained in one housing, are both “systems”.

The embodiments of the present disclosure are not limited to the above-described embodiments, and various modifications can be made without departing from the essential spirit of the present disclosure.

For example, a form in which some or all of the above-described embodiments are combined as appropriate may be employed as well.

For example, the present disclosure may be configured through cloud computing in which a plurality of devices share and cooperatively process one function over a network.

In addition, each step described with reference to the foregoing flowcharts can be executed by a single device, or in a distributed manner by a plurality of devices.

Furthermore, when a single step includes a plurality of processes, the plurality of processes included in the single step can be executed by a single device, or in a distributed manner by a plurality of devices.

Note that the effects described in the present specification are merely illustrative and not limiting, and effects aside from those described in the present specification may be obtained as well.

The present disclosure can be configured as follows.
(1) A data processing device including:
a control unit that, based on a result of determining a sameness of subjects using DVS data output from sensors that output temporal luminance changes in optical signals as event data, controls data transfer of image frame data in which the subjects have been shot on a frame basis.
(2) The data processing device according to (1),
wherein based on the result of determining the sameness of the subjects using the DVS data, the control unit controls transmission of at least one of a plurality of pieces of the image frame data in which the subjects have been shot to be on or off.
(3) The data processing device according to (1) or (2),
wherein the control unit controls whether to transmit at least one piece of the image frame data, obtained by the data processing device itself, to another device.
(4) The data processing device according to any one of (1) to (3),
wherein the control unit controls whether a first device is to transmit at least one piece of the image frame data to a second device.
(5) The data processing device according to any one of (1) to (4),
wherein based on the result of determining the sameness of the subjects using the DVS data, the control unit controls generation of difference data between two pieces of the image frame data in which the subjects have been shot.
(6) The data processing device according to any one of (1) to (5),
wherein the control unit specifies a capture timing to the sensors that generate the two pieces of the image frame data in which the subjects have been shot, and
generates difference data between the two pieces of the image frame data in which the subjects have been shot at the capture timing specified.
(7) The data processing device according to any one of (1) to (6),
wherein the control unit transmits base image frame data of one of the two pieces of the image frame data in which the subjects have been shot, as well as the difference data, at the specified capture timing, to another device.
(8) The data processing device according to any one of (1) to (7),
wherein based on the result of determining the sameness of the subjects using the DVS data, the control unit controls assignment of viewports of the image frame data in which the subjects have been shot.
(9) The data processing device according to any one of (1) to (8),
wherein the control unit transmits, to a first device, viewport control information that controls the assignment of the viewports to the image frame data.
(10) The data processing device according to any one of (1) to (9),
wherein the control unit transmits, to a second device, a plurality of pieces of the image frame data having different viewport assignments obtained by the data processing device itself.
(11) The data processing device according to any one of (1) to (10),
wherein the control unit controls the first device such that the first device transmits, to a second device, the image frame data for which the assignment of the viewport is different from another device.
(12) The data processing device according to any one of (1) to (11),
wherein the control unit determines the sameness of the subjects using two pieces of the DVS data when the event data, which is obtained irregularly, has been accumulated to at least a predetermined threshold.
(13) The data processing device according to any one of (1) to (12),
wherein two of the sensors that output the DVS data used to determine the sameness of the subjects belong to a same group, and the control unit recognizes that the two of the sensors belong to the same group by querying another device.
(14) A data processing method including:
a data processing device controlling, based on a result of determining a sameness of subjects using DVS data output from sensors that output temporal luminance changes in optical signals as event data, data transfer of image frame data in which the subjects have been shot on a frame basis.
(15) A data processing system including:
a first data control unit that, based on a result of determining a sameness of subjects using DVS data output from sensors that output temporal luminance changes in optical signals as event data, controls data transfer, to a cloud server, of image frame data in which the subjects have been shot on a frame basis; and
a second data control unit that transmits the image frame data to the cloud server based on the control performed by the first data control unit.

### REFERENCE SIGNS LIST

1 Image network system
11 (11-1, 11-2) User equipment
12 (12-1, 12-2) Edge application server (EAS)
13 Sensor data monitor
14 Edge enabler server (EES)
15 Orchestrator
16 Authentication processing server
21 DVS sensor
22 FIS sensor
23 Edge application client (EAC)
101 DVS data source module
102 Image frame source module
111 DVS data sync module
112 Image frame sync module
121 DVS data sameness determination module
122 Image frame transfer module
123 Image frame control module
131 Attribute registration module
301 CPU
302 ROM
303 RAM
306 Input unit
307 Output unit
308 Storage unit
309 Communication unit
310 Drive

1. A data processing device comprising:
a control unit that, based on a result of determining a sameness of subjects using DVS data output from sensors that output temporal luminance changes in optical signals as event data, controls data transfer of image frame data in which the subjects have been shot on a frame basis.

2. The data processing device according to claim 1,
wherein based on the result of determining the sameness of the subjects using the DVS data, the control unit controls transmission of at least one of a plurality of pieces of the image frame data in which the subjects have been shot to be on or off.

3. The data processing device according to claim 2,
wherein the control unit controls whether to transmit at least one piece of the image frame data, obtained by the data processing device itself, to another device.

4. The data processing device according to claim 2,
wherein the control unit controls whether a first device is to transmit at least one piece of the image frame data to a second device.

5. The data processing device according to claim 1,
wherein based on the result of determining the sameness of the subjects using the DVS data, the control unit controls generation of difference data between two pieces of the image frame data in which the subjects have been shot.

6. The data processing device according to claim 5,
wherein the control unit specifies a capture timing to the sensors that generate the two pieces of the image frame data in which the subjects have been shot, and
generates difference data between the two pieces of the image frame data in which the subjects have been shot at the capture timing specified.

7. The data processing device according to claim 6,
wherein the control unit transmits base image frame data of one of the two pieces of the image frame data in which the subjects have been shot, as well as the difference data, at the specified capture timing, to another device.

8. The data processing device according to claim 1,
wherein based on the result of determining the sameness of the subjects using the DVS data, the control unit controls assignment of viewports of the image frame data in which the subjects have been shot.

9. The data processing device according to claim 8,
wherein the control unit transmits, to a first device, viewport control information that controls the assignment of the viewports to the image frame data.

10. The data processing device according to claim 8,
wherein the control unit transmits, to a second device, a plurality of pieces of the image frame data having different viewport assignments obtained by the data processing device itself.

11. The data processing device according to claim 8,
wherein the control unit controls a first device such that the first device transmits, to a second device, the image frame data for which the assignment of the viewport is different from another device.

12. The data processing device according to claim 1,
wherein the control unit determines the sameness of the subjects using two pieces of the DVS data when the event data, which is obtained irregularly, has been accumulated to at least a predetermined threshold.

13. The data processing device according to claim 1,
wherein two of the sensors that output the DVS data used to determine the sameness of the subjects belong to a same group, and
the control unit recognizes that the two of the sensors belong to the same group by querying another device.

14. A data processing method comprising:
a data processing device controlling, based on a result of determining a sameness of subjects using DVS data output from sensors that output temporal luminance changes in optical signals as event data, data transfer of image frame data in which the subjects have been shot on a frame basis.

15. A data processing system comprising:
a first data control unit that, based on a result of determining a sameness of subjects using DVS data output from sensors that output temporal luminance changes in optical signals as event data, controls data transfer, to a cloud server, of image frame data in which the subjects have been shot on a frame basis; and
a second data control unit that transmits the image frame data to the cloud server based on the control performed by the first data control unit.
